(19) United States
(12) Patent Application Publication
(10) Pub. No.: US 2024/0104675 A1
(43) Pub. Date: Mar. 28, 2024

(54) INFORMATION PROCESSING APPARATUS, INFORMATION PROCESSING METHOD AND STORAGE MEDIUM FOR TRANSACTING REAL ESTATE

(71) Applicant: Luciane Serifovic, Whitestone, NY (US)

(72) Inventor: Luciane Serifovic, Whitestone, NY (US)

(21) Appl. No.: 18/374,000

(22) Filed: Sep. 28, 2023

Related U.S. Application Data
(60) Provisional application No. 63/410,664, filed on Sep. 28, 2022.

(51) Int. Cl. G06Q 50/16; G06Q 30/0601; H04L 9/40

(52) U.S. Cl. CPC G06Q 50/16; G06Q 30/0625; H04L 63/0884

(57) ABSTRACT

An artificial intelligence system is disclosed for managing real estate transactions. The system includes a processor and a non transitory computer-readable medium containing instructions for performing various functions. Upon authenticating a user, the system initializes a search module executing on an electronic device. The system receives a request from the search module, which includes user input from a touch-driven interface. Based on the request, the system determines relevant transactions for real estate properties or third-party service providers. The system formulates a response that includes aggregated content related to the transactions from the current login session. The response, associated with the user's login session, is then sent to the search module for display on the electronic device. The response includes transaction timelines for the identified transactions, providing the user with a comprehensive overview of their real estate transactions.

### CROSS-REFERENCE TO RELATED APPLICATIONS SECTION

This application is a U.S. Non-Provisional Patent Application entitled, “INFORMATION PROCESSING APPARATUS, INFORMATION PROCESSING METHOD AND STORAGE MEDIUM FOR TRANSACTING REAL ESTATE,” which claims priority to co-pending U.S. Provisional Patent Application No. 63/410,664 filed Sep. 28, 2022, entitled, “INFORMATION PROCESSING APPARATUS, INFORMATION PROCESSING METHOD AND STORAGE MEDIUM FOR TRANSACTING REAL ESTATE,” the entire contents of which are hereby incorporated by reference in their entirety.

### FIELD OF THE EMBODIMENTS

The field of the invention and its embodiments generally relate to artificial intelligence technology for transacting real estate.

### BACKGROUND OF THE EMBODIMENTS

The real estate market has significantly grown. For example, in 2020, 6.1 million homes were sold in the U.S., among which 5.6 million homes were sold by real estate agents and the rest were sold by owners.

Transactions of real estate generally involve 20+ players including buyers, sellers, listing agents, their respective real estate agents, mandatory real estate attorneys in some states, inspectors, contractors, escrow agents, title companies, lenders, insurance agents, etc. (See FIGS. 3 and 5.) Each of the players has roles specific to the player and different from those of other players. For example, the title companies ensure that valid title to the real estate is held by the seller and that the valid title is securely transferred from the seller to the buyer. These roles are to be performed by the title companies and no one else. Likewise, the other players perform their own roles. While performing their roles, many papers specific to each task are involved which necessitate heightened attention by the other players involved in the real estate transaction. However, they do not communicate with each other because they use different platforms.

Most buyers and sellers do not transact many real estate transactions during their lifetime to have experience dealing with the process and its many steps. Thus, many, if not all, of the tasks that buyers and sellers are supposed to do are generally new to the buyers and sellers, meaning that the buyers and sellers must look for different sources or trusted advisors for each step of the process. (FIG. 5.) Thus, the buyers and sellers are most of the time in the dark side about the next steps. On the other hands, even experienced agents, attorneys, inspectors, and other players must keep up with the current laws and codes of each state, county, and even city that they transact in, and need to familiarize themselves with the ever-changing laws, rules, regulations, codes, software programs, and forms. Also, they are too busy to be proactive in keeping everyone aware of the status of the process.

Current approaches to real estate transaction management involve manual processes and fragmented systems that can be time-consuming and prone to errors. Traditional methods often require multiple platforms and tools to handle various aspects of a real estate transaction, such as property listings, client communication, document management, and coordination with third-party service providers. These systems typically lack integration and automation, leading to inefficiencies and delays in the transaction process.

One common approach is to use standalone software applications or web-based platforms that focus on specific aspects of real estate transaction management, such as property listing databases or document management systems. These systems often require manual data entry and lack the ability to provide a comprehensive view of the entire transaction process. Additionally, they may not have the capability to integrate with other systems or provide real-time updates.

Another approach involves using customer relationship management (CRM) software to manage real estate transactions. CRM systems are designed to track and manage customer interactions, but they may not have the specific features and functionality required for real estate transaction management. These systems often require customization and integration with other tools to handle the unique requirements of the real estate industry.

Furthermore, some existing solutions attempt to incorporate artificial intelligence (AI) technologies into real estate transaction management. These AI-based systems may use machine learning algorithms to analyze data and provide recommendations or predictions. Many of these approaches often lack the ability to seamlessly integrate with existing systems and may require significant customization and training to be effective.

However, none of these approaches have provided a comprehensive solution that combines the features described in this disclosure. The present invention aims to address the limitations of existing real estate transaction management systems by providing preestablished steps involving the entire real estate process while guiding the users through the process an artificial intelligence system that integrates various functionalities, automates processes, and provides a user-friendly interface for efficient and streamlined real estate transaction management.

It is to be understood that this background of the technology section is, in part, intended to provide a useful background for understanding the technology. However, this background of the technology section may also include ideas, concepts, or recognitions that were not part of what was known or appreciated by those skilled in the pertinent art prior to a corresponding effective filing date of the subject matter disclosed here.

### SUMMARY OF THE EMBODIMENTS

In accordance with the principles of the present invention, an artificial intelligence system is disclosed for managing real estate transactions. The system includes a processor and a non-transitory computer-readable medium containing instructions for performing various functions. Upon authenticating a user, the system initializes a search module executing on an electronic device. The system receives a request from the search module, which includes user input from a touch-driven interface. Based on the request, the system determines relevant transactions for real estate properties or third-party service providers. The system formulates a response that includes aggregated content related to the transactions from the current login session. The response, associated with the user's login session, is then sent to the search module for display on the electronic device. The response includes transaction timelines for the identified transactions, providing the user with a comprehensive overview of their real estate transactions, and which also includes improvements that overcome the limitations of prior real estate management systems, is now met by a new, useful, and non-obvious invention.

In some aspects, the techniques described herein relate to an artificial intelligence system for real estate transaction management, including: a processor; and a non-transitory computer-readable medium including instructions for: authenticating a user in a system search module; responsive to authenticating, initializing the system search module executing on an electronic device; receiving a request from the system search module at the electronic device, wherein the request includes a current interaction entered by the user in a graphic user interface portion of a touch driven interface displayed at the electronic device, and wherein the request represents at least a portion of a current login session with the user:, determining one or more transactions for one or more real estate properties for sale or one or more transactions for one or more third party service providers from the request from the system search module; formulating a response to the request that includes aggregated content related to the one or more transactions for the one or more real estate properties for sale or the one or more transactions for the one or more third party service providers from the current login session; and sending the formulated response to the system search module to be displayed on the electronic device, wherein the response includes a first transaction timeline for a first list of the one or more transactions for the one or more real estate properties for sale or a second transaction timeline for a second list of the one or more transactions for the one or more third party service providers and wherein the response is associated with the current login session associated with the user.

In some aspects, the techniques described herein relate to a system, further including: an AI engine, the AI engine determining the one or more transactions for the one or more real estate properties for sale or the one or more transactions for the one or more third party service providers from the request from the system search module.

In some aspects, the techniques described herein relate to a system, wherein the AI engine is a machine learning algorithm that is trained by at least one supervised, unsupervised, semi-supervised, or a reinforced manner.

In some aspects, the techniques described herein relate to a system, wherein the AI engine includes a pre-processing module that receives the request and the current login session and creates the first transaction timeline for the first list of the one or more transactions for the one or more real estate properties for sale or the second transaction timeline for the second list of the one or more transactions for the one or more third party service providers.

In some aspects, the techniques described herein relate to a system, wherein the AI engine includes a post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

In some aspects, the techniques described herein relate to a system, further including: a natural language processing extraction module determining the one or more transactions for the one or more real estate properties for sale or the one or more transactions for the one or more third party service providers from the request from the system search module.

In some aspects, the techniques described herein relate to a system, wherein the natural language processing extraction module includes a pre-processing module that receives the request and the current login session and creates the first transaction timeline for the first list of the one or more transactions for the one or more real estate properties for sale or the second transaction timeline for the second list of the one or more transactions for the one or more third party service providers.

In some aspects, the techniques described herein relate to a system, wherein the natural language processing extraction module includes a post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

In some aspects, the techniques described herein relate to a system, wherein the non-transitory computer-readable medium further includes instructions for: providing accessory services, the accessory services being a lifestyle guide, basics about real estate, design suggestions for colors of paint, or information about taxes and insurance, or luxury items.

In some aspects, the techniques described herein relate to a system, further including a document repository, the document repository configured to retain one or more documents associated with the first transaction timeline or the second transaction timeline.

In some aspects, the techniques described herein relate to a system, wherein the aggregated content is provided by an AI document automation system, the AI document automation system generating one or more documents coupled to a compliance and regulatory system based on a location of a first transaction of the one or more transactions or a second transaction of the one or more transactions from the request from the system search module.

In some aspects, the techniques described herein relate to a system, wherein the non-transitory computer-readable medium further includes instructions for: providing communication between a first entity and a second entity associated with the one or more transactions for the one or more real estate properties for sale or the one or more transactions for the one or more third party service providers from the request from the system search module.

In some aspects, the techniques described herein relate to a system, wherein the non-transitory computer-readable medium further includes instructions for: providing financial payment transactions between a first entity and a second entity associated with the one or more transactions for the one or more real estate properties for sale or the one or more transactions for the one or more third party service providers from the request from the system search module.

In some aspects, the techniques described herein relate to a computer-implemented method for an artificial intelligence system for real estate transaction management, including: executing on an electronic device; receiving a request from a system search module at the electronic device, wherein the request includes a current interaction entered by a user in a graphic user interface portion of a touch driven interface displayed at the electronic device, and wherein the request represents at least a portion of a current login session with the user; determining one or more transactions for one or more real estate properties for sale or one or more transactions for one or more third party service providers from the request from the system search module; formulating a response to the request that includes aggregated content related to the one or more transactions for the one or more real estate properties for sale or the one or more transactions for the one or inure third party service providers from the current login session; and sending the formulated response to the system search module to be displayed on the electronic device, wherein the response includes a first transaction timeline for a first list of the one or more transactions for the one or more real estate properties for sale or a second transaction timeline for a second list of the one or more transactions for the one or more third party service providers and wherein the response is associated with the current login session associated with the user.

In some aspects, the techniques described herein relate to a method, further including: an AI engine, the AI engine determining the one or more transactions for the one or more real estate properties for sale or the one or more transactions for the one or more third party service providers from the request from the system search module, and the AI engine is a machine learning algorithm that is trained by at least one supervised, unsupervised, semi-supervised, or a reinforced manner.

In some aspects, the techniques described herein relate to a method, wherein the AI engine includes: a pre-processing module that receives the request and the current login session and creates the first transaction timeline for the first list of the one or more transactions for the one or more real estate properties for sale or a second transaction timeline for the second list of the one or more transactions for the one or more third party service providers; and a post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

In some aspects, the techniques described herein relate to a method, further including: a natural language processing extraction module determines the one or more transactions for the one or more real estate properties for sale or the one or more transactions for the one or more third party service providers from the request from the system search module.

In some aspects, the techniques described herein relate to a method, wherein the natural language processing extraction module includes: a pre-processing module that receives the request and the current login session and creates the first transaction timeline for the first list of the one or more transactions for the one or more real estate properties for sale or the second transaction timeline for the second list of the one or more transactions for the one or more third party service providers; and a post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

In some aspects, the techniques described herein relate to a method, further including: providing communication between a first entity and a second entity associated with the one or more transactions for the one or more real estate properties for sale or the one or more transactions for the one or more third party service providers from the request from the system search module.

In some aspects, the techniques described herein relate to a method, further including: providing financial payment transactions between a first entity and a second entity associated with the one or more transactions for the one or more real estate properties for sale or the one or more transactions for the one or more third party service providers from the request from the system search module.

### BRIEF DESCRIPTION OF THE DRAWINGS

The accompanying drawings are incorporated herein and form a part of the specification.

FIG. 1 illustrates a display of an electronic device configured to show an operational sequence that may he performed when running a real estate transaction management software system driven by artificial intelligence (AI).

FIG. 2 illustrates a display of an electronic device configured to show an operational sequence that may be performed when running a real estate transaction management software system driven by artificial intelligence (AI) to provide accountable and trusted services to the users in real estate transactions.

FIG. 3 illustrates a listing of a plurality of real estate transactions that require management and are contributors to the problem of the current real estate experience.

FIG. 4 illustrates how currently a business directly are managed by a pdf document for brokerage firms that is outdated and what agents are offering clients, with this platform a listing of a plurality of resources in home service directory configured to be easily created and accessible by agent in a single platform for real estate transactions.

FIG. 5 illustrates a display of how current communication is separate, fragmented, and multiple apps do not communicate with one another. The current operational sequence that may be performed and all vendors involved in single a real estate transaction and how complicated this is for the average consumer.

FIG. 6 illustrates an electronic device showing an operational sequence that may be performed when running a real estate transaction management software system with clearly identifying the vendor and their role in the real estate transaction all in the same platform.

FIG. 7 illustrates an electronic device showing an operational sequence that may be performed when running a real estate transaction management for each service provider and each step performed in the transaction clearly identifiable along with the payment performed along with tracked earned commissions by the real estate agents.

FIG. 8 illustrates an electronic device showing an operational sequence that may be performed when running a real estate transaction search and seeing multiple listings from multiple aggregator sites in one page.

FIG. 9 illustrates an electronic device showing an operational sequence that may be performed when running a real estate transaction management software system with all potential services needed by a user with recommended trusted service providers and concierge style services making a better experience for the consumer driven by artificial intelligence (AI). Clear progress status where clients understand exactly where they stand in the real estate transaction.

FIG. 10 illustrates an electronic device showing an operational sequence that may be performed when running a real estate transaction management software system all actions performed under one platform, search and organizing listings from multiple sites, communicating with all service providers under one cohesive platform, progress status from each service providers and payments made to all in one easy to use application.

FIG. 11 illustrates the log in page an electronic device showing an operational sequence that may be performed when running a real estate transaction management software system driven by artificial intelligence (AI).

FIG. 12 illustrates an electronic device showing an operational sequence that may be performed when running a real estate transaction management software system including search and seeing multiple listings from multiple aggregator sites in one-page, favorite listings, and organized listings recommended by their agent.

FIG. 12A illustrates an electronic device showing an embodiment of the operational sequence of FIG. 12 that may be performed when running a real estate transaction management software system including being able to manage and organize the properties consumer visited and liked, visited, and not liked and star rating to easily remember which properties they are most interested in potentially purchasing along with whoever you want involved in the process.

FIG. 13 illustrates an electronic device showing an operational sequence that may be performed when running a real estate transaction management software system seeing all listings, organized listings into different folders pre-set or created by the consumer. including being able to manage and organize the properties consumer visited and liked, visited, and not liked and star rating to easily remember which properties they are most interested in potentially purchasing along with whoever you want involved in the process.

FIG. 13A illustrates an electronic device showing an embodiment of the operational sequence of FIG. 13 that may be performed when running a real estate transaction management software system seeing all listings, organized listings into different folder pre-set or created by the consumer including being able to manage and organize the properties consumers visited and liked, visited and not liked and star rating to easily remember which properties they are most interested in potentially purchasing along with whoever you want involved in the process.

FIG. 14 illustrates an electronic device showing an operational sequence that may be performed when running a real estate transaction management software system where consumer can add any URL link from any real estate websites and the ability to easily search.

FIG. 14A illustrates an electronic device showing an embodiment of the operational sequence of FIG. 14 that may be performed when running a real estate transaction management software system where each listing receives its own rating, (liked) personal notes, photos and videos.

FIG. 15 illustrates an electronic device showing an operational sequence that may be performed when running a real estate transaction management software system where each listing receives its own rating, (Dislike) personal notes, photos and videos.

FIG. 16 illustrates an electronic device showing an operational sequence that may be performed when running a real estate transaction management software system where consumers can easily organize listings and create custom folders to ease their real estate search.

FIG. 17 illustrates an electronic device showing an operational sequence that may be performed when running a real estate transaction management software system and all possible services needed during the real estate transaction and beyond.

FIG. 17A illustrates an electronic device showing an embodiment of the operational sequence of FIG. 17 that may be performed when running a real estate transaction management software system.

FIG. 18 illustrates an electronic device showing an operational sequence that may be performed when running a real estate transaction management software system driven by artificial intelligence (AI) clear understandable progress for each service provider and guidance on what to expect next along with valuable advice.

FIG. 19 illustrates an electronic device showing an operational sequence that may be performed when running a real estate transaction management software system for each service provider and each step performed in the transaction clearly identifiable along with the payment performed along with tracked earned commissions by the real estate agents.

FIG. 20 illustrates an electronic device showing an operational sequence that may be performed when running a real estate transaction management software system where consumer can easily review recent transactions along with payments made all in one platform.

FIG. 21 illustrates an electronic device showing an operational sequence that may be performed when running a real estate transaction management software system where consumer can easily review services in progress and recent transactions along with invoices all in one platform.

FIG. 22 illustrates an electronic device showing an operational sequence that may be performed when running a real estate transaction management software system make payments made all in one platform.

FIG. 23 illustrates an electronic device showing an operational sequence that may be performed when running a real estate transaction management software system driven by artificial intelligence (AI)consumers can get advice, recommendations instantly.

FIG. 24 is a block diagram illustrating an artificial intelligence system, according to some embodiments of the present disclosure.

FIG. 25 is a block diagram further illustrating the artificial intelligence system from FIG. 25, according to some embodiments of the present disclosure.

FIG. 26 is a block diagram further illustrating the artificial intelligence system from FIG. 24, according to some embodiments of the present disclosure.

FIG. 27 is a block diagram further illustrating the artificial intelligence system from FIG. 24, according to some embodiments of the present disclosure.

FIG. 28 is a block diagram further illustrating the artificial intelligence system from FIG. 24, according to some embodiments of the present disclosure.

FIG. 29 is a flowchart illustrating a computer-implemented method, according to some embodiments of the present disclosure.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should he understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B), in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

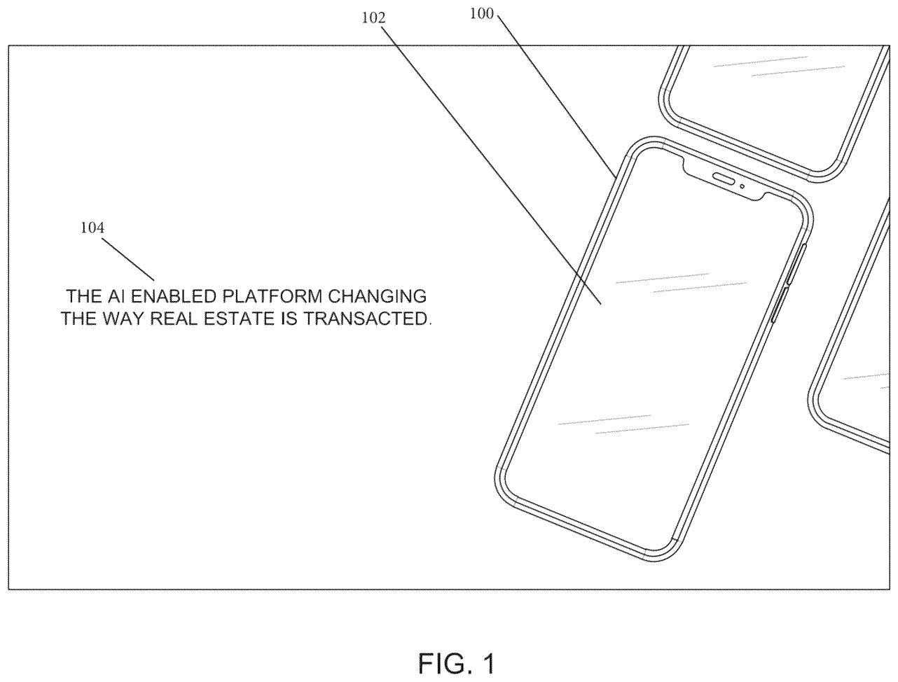

FIG. 1 illustrates a display 102 of an electronic device 100 configured to show an operational sequence that may be performed when running a real estate transaction management software system driven by artificial intelligence (AI). The current platform disclosed here is driven by artificial intelligence (AI) and enables step 104 of changing the way that real estate is transacted. (See FIG. 1,) In particular, the current platform is trained by AI and securely provides instant responses to user's requests.

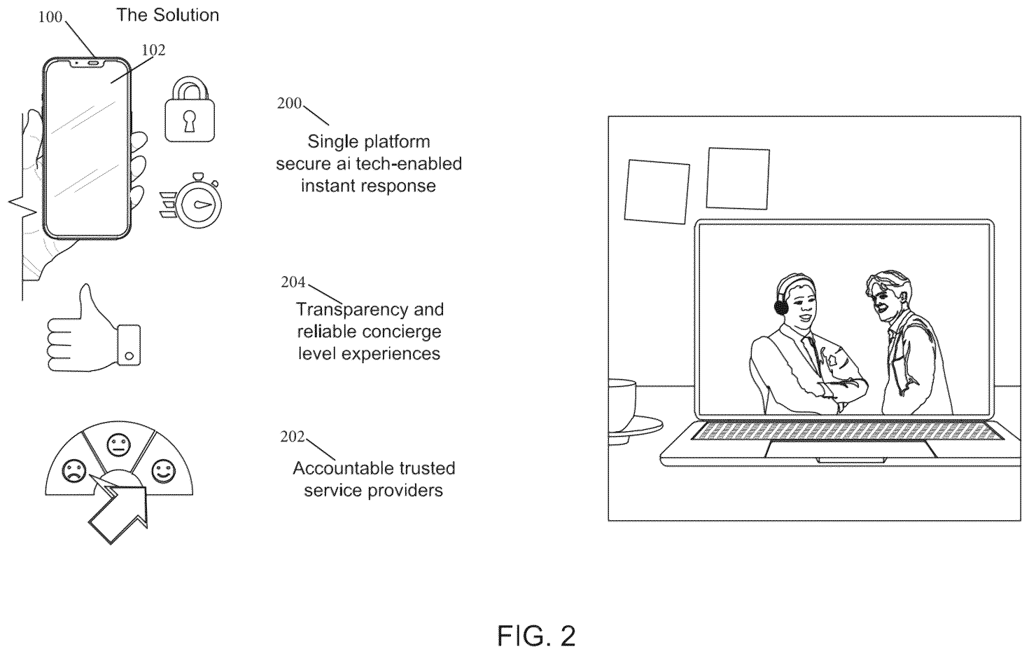

FIG. 2 illustrates a display 102 of an electronic device 100 configured to show an operational sequence that may be performed when running a real estate transaction management software system 200 driven by artificial intelligence (AI) to provide accountable 202, transparent 204, and trusted services to the users in real estate transactions. The services provided by the current platform are transparent and provide reliable experience to the users. Further, the AI-driven platform provides accountable and trusted services to the users in real estate transactions. (See FIG. 2.) Furthermore, the AI-driven platform helps the buyers, sellers, and agents organize their sales search and will allow the agent to recommend business directories for experienced and trusted vendors to their clients. Thereby, vendors get more business and can update everyone involved in the transaction, making the vendors more efficient, and buyers and sellers have access to the progress via a slider bar or similar graphical illustrations with details of the entire process, and with AI predictions. In this way, everyone knows exactly what to expect and the next steps of the process.

To create an AI-driven platform for real estate transactions with features including, but not limited to, property search assistance, vendor recommendations, progress tracking, and AI predictions, various algorithms and techniques may be employed. In an example, some types of algorithms and techniques that may be used:

### 1. Recommendation Algorithms:

Collaborative Filtering: Recommends properties or vendors based on the behavior and preferences of similar users. Content-Based Filtering: Recommends properties or vendors based of features or attributes matching user preferences. Hybrid Recommendation Systems: Combine multiple recommendation approaches for more accurate suggestions.

### 2. Predictive Analytics Algorithms:

Regression Analysis: Predicts property prices, rental yields, or other real estate-related metrics based on historical data and relevant features. Time Series Forecasting: Predicts trends in real estate markets, such as price movements, demand, or supply. Machine Learning Models (e.g., Random Forest, Gradient Boosting): Utilized for complex predictive modeling tasks.

### 3. Natural Language Processing (NLP):

Sentiment Analysis: Analyzes user reviews and feedback to determine sentiment towards properties, vendors, or the overall platform. Text Processing for Property Descriptions: Extracts relevant information from property listings to improve search results.

### 4. Image Processing and Computer Vision:

Object Recognition: Identifies objects or features in property images(e.g., rooms, amenities). Image Classification: Categorizes images (e.g., interior, exterior) to enhance property listings.

### 5. Search and Filtering Algorithms:

Key word Matching: Matches user queries with relevant property listings or vendor profiles. Location-Based Search: Utilizes geospatial algorithms to find properties within specific regions. Filtering by Attributes: Allows users to narrow down search results based on specific criteria (e.g., price range, number of bedrooms.

### 6. Clustering and Segmentation:

Property Clustering: Groups similar properties together based on features like location, price, and amenities, User Segmentation: Divides users into groups with similar preferences and behaviors for personalized recommendations.

### 7. Graph Algorithms:

Social Network Analysis: Analyzes connections and relationships between users, agents, and vendors to identify influential parties or trends.

### 8. Machine Learning for Vendor Recommendations:

Regression or Classification Models: Predicts the suitability of vendors based on historical data and user preferences. Reinforcement Learning: Optimizes vendor recommendations over time by learning from user feedback.

### 9. Progress Tracking Algorithms:

Workflow Automation: Defines and manages the sequential steps of a transaction, tracking progress and triggering notifications.

### 10. Data Mining and Pattern Recognition:

Market Trend Analysis: Identifies patterns in historical data to make predictions about future market trends.

The aforementioned algorithms, combined with the appropriate hardware and software components, may form the foundation of the described AI-driven platform that provides valuable services to buyers, sellers, and agents in the real estate industry. Additionally, the platform may benefit from a robust data infrastructure, cloud services for scalability, and secure communication protocols to ensure a reliable and trustworthy user experience.

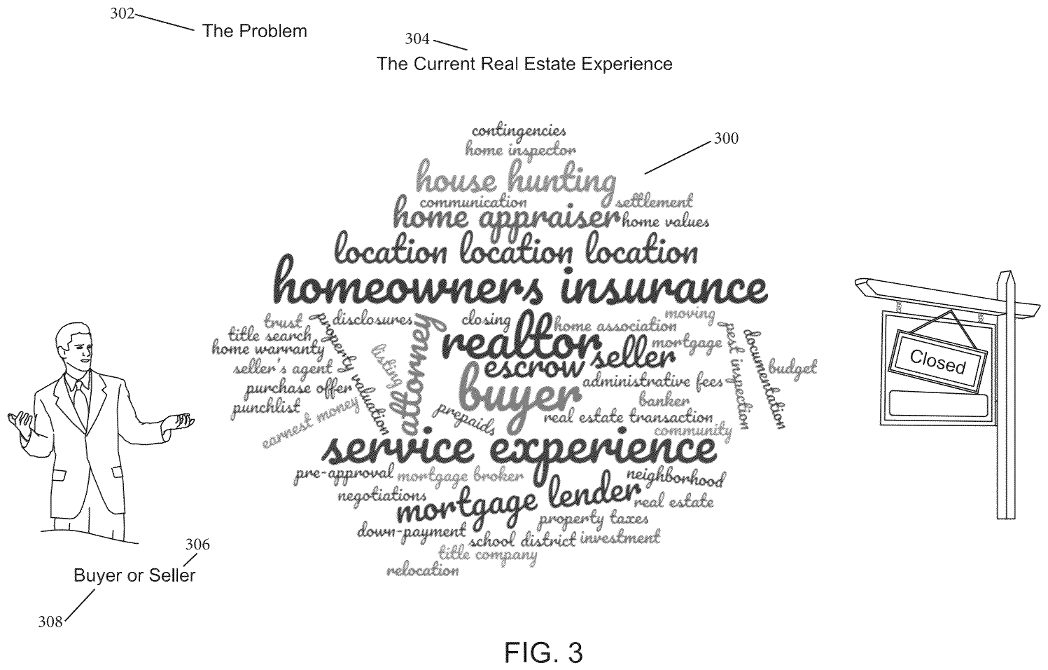

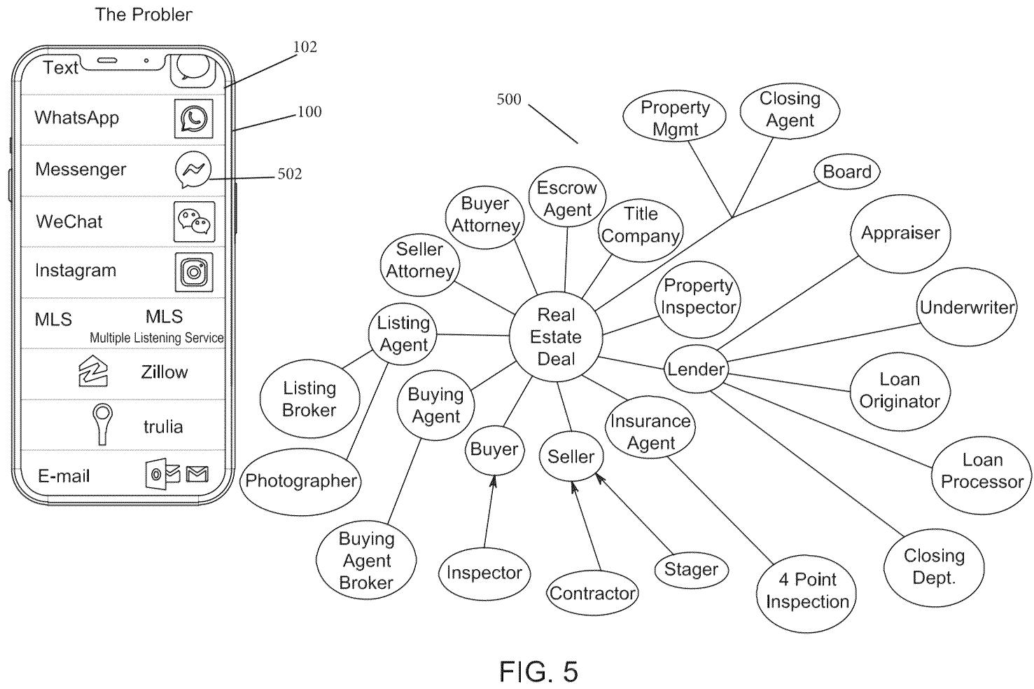

FIG. 3 illustrates a listing of a plurality of real estate transactions 300 that require management and are contributors of problem 302 of the current real estate experience 304. As described above, when a seller 306 wants to sell a house or a buyer 308 wants to buy a house, they must interact with one or more third parties 500 including, but not limited to, departments, divisions, and/or individuals including, but not limited to, agents, mortgage brokers, inspectors, real estate attorneys, title companies, home insurance companies, escrow agents, etc. (See FIGS. 3 and 5.) Transacting with these players and reviewing documents increases the burden on both buyers and sellers. Even if they find the “right” players, there is usually no past experience to know if these players are licensed, reliable, trustworthy, and honest.

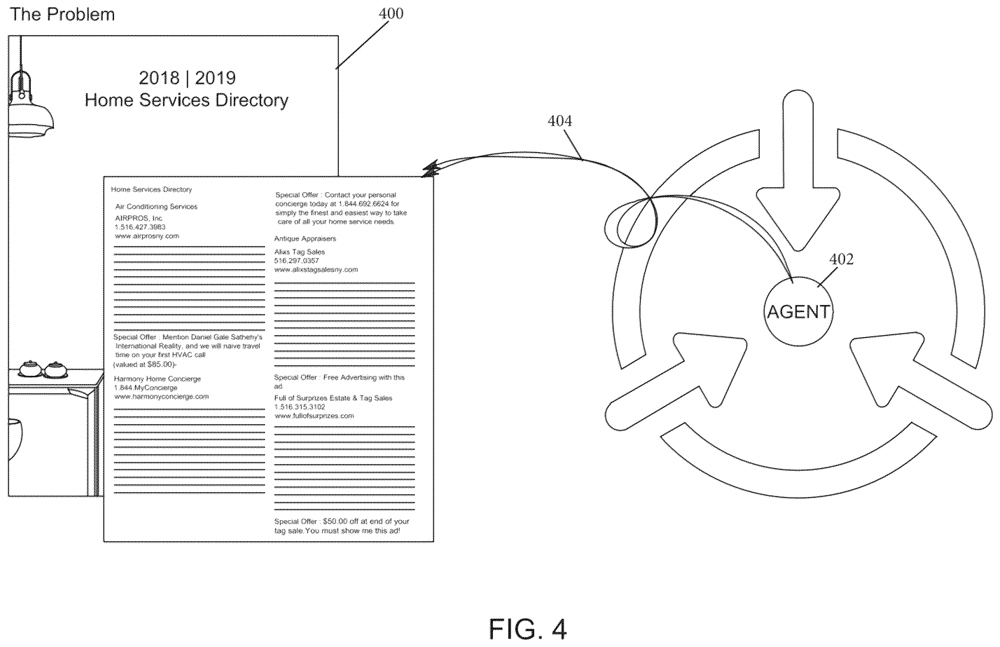

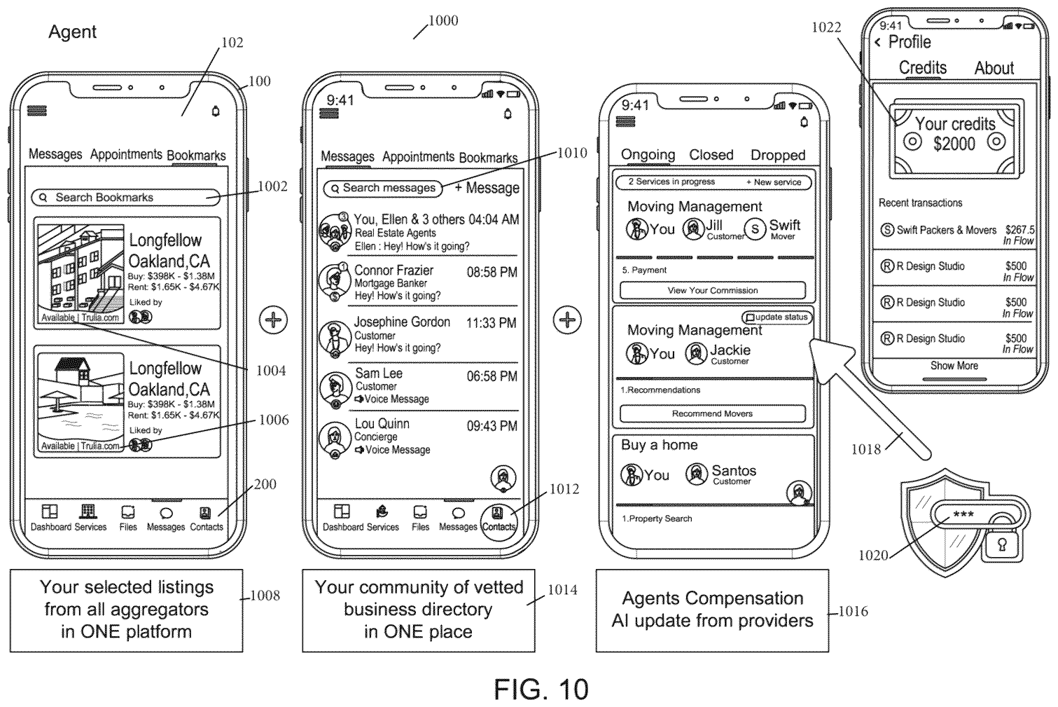

FIG. 4 illustrates a listing of a plurality of resources in home service directory 400 configured to be easily accessible 404 by agent 402 in a single platform for real estate transactions. The platform described herein aggregates and provides everything required in a real estate transaction in one location. The AI-driven platform stores lists of reliable acid trusted players, including listing agents, their respective real estate agents, mandatory real estate attorneys in some states, inspectors, contractors, escrow agents, title companies, lenders, insurance agents, etc. (See FIG. 4 and the middle screenshot in FIG. 10.) Thereby, agents, buyers, and sellers are more organized with all properties of interest without leaving the platform.

FIG. 5 illustrates a display 102 of an electronic device 100 configured to show an operational sequence that may be performed to consolidate a plurality of Apps 502 and/or one or more third parties 500 including, but not limited to, departments, divisions, and/or individuals when running a real estate transaction management software system driven by artificial intelligence (AI). The platform may recommend preferred vendors to agents and keep track of all transactions. Agents may be able to track commissions within the platform. Sellers and buyers can get recommendations from businesses that agents have personal experience, keep track of every step in the transaction of real estate, and identify anyone who is involved in the transaction.

The platform also provides history of transactions of real estate, in which the various players were involved. The users of the platform, such as the buyers, can track amounts of money paid for each task, which includes payments to title companies, inspectors, and attorneys, tax paid to local governments, commissions to agents, service charges, etc. Further, users may be able to see trends of each fee or payment.

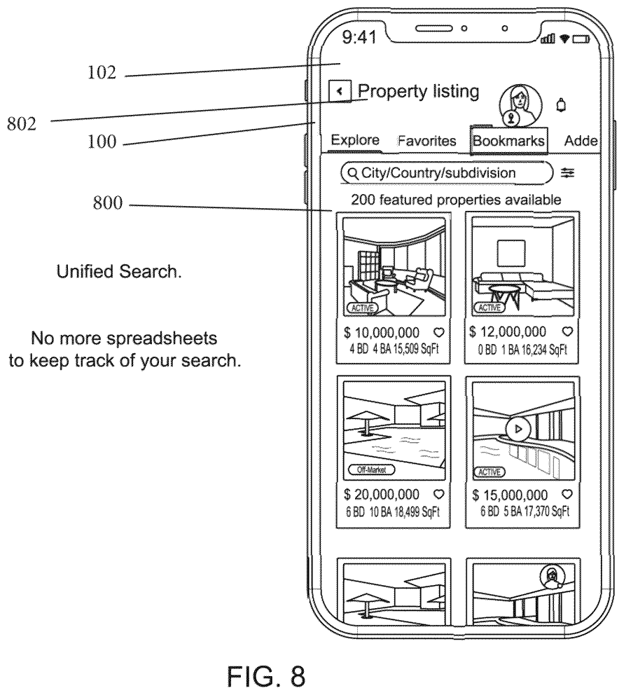

FIG. 8 illustrates a display 102 of an electronic device 100 showing operational sequence 800 that may be performed to review property listings 802 from a plurality of sources when running a real estate transaction management software system 200 driven by artificial intelligence (AI). Traditionally, when buyers look for houses to buy, they visit many different websites featuring houses for sale, and create a spreadsheet file with the links to each respective house they identified and like. This is not necessary with the present platform, because the platform is capable of aggregating houses from various sources and storing the list of identified houses, thereby enabling users to do every step from finding the home they like to conducting the transaction in one place. Further, the platform provides multimedia (e.g., pictures, audios, videos, and three-dimensional presentations, etc.) for each house in the list saved therein.

The platform may function as a document repository for all transactions of real estate. As seller's agents, users may be able to find forms of contracts, such as listing contracts as an exclusive or non-exclusive agent in the platform according to the state where the house is located. Since there are different requirements for each state, the platform saves proper forms for each state.

Users as sellers may be able to find any forms necessary to sell a house. For example, a non-NY resident as a seller needs to fill out an IT-2663 form to sell a house located in New York and can find the form in the platform. Likewise, users as buyers may be able to find all the forms to be signed before and during the closing in the platform.

Not only as a document repository, the platform also provides a list of documents to buyers, sellers, agents, etc., according to the state where the real estate is located.

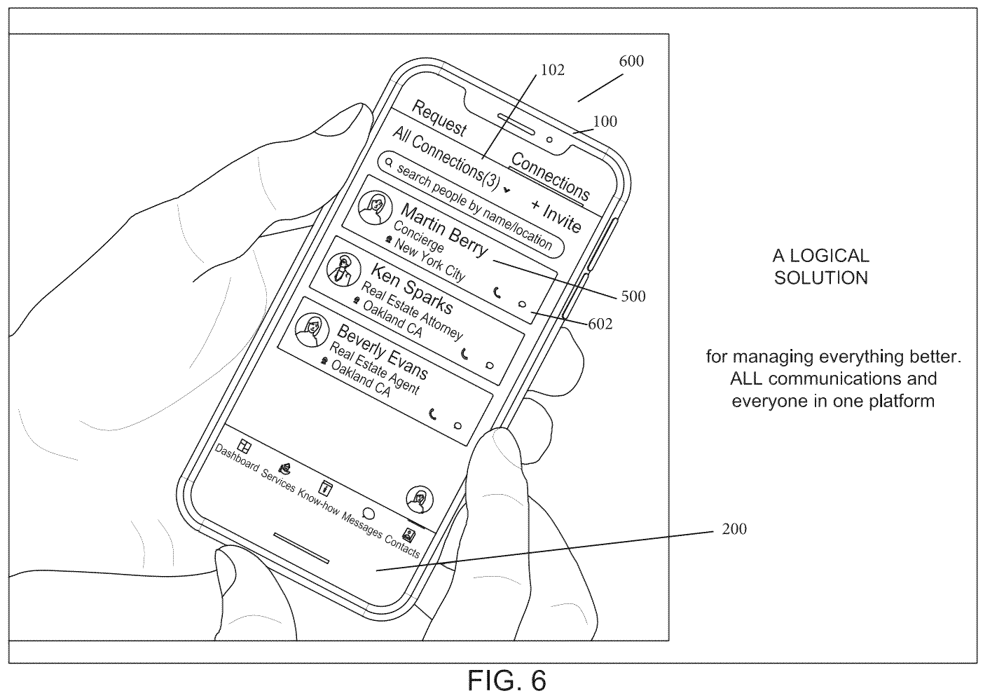

FIG. 6 illustrates a display 102 of an electronic device 100 showing operational sequence 600 that may be performed to consolidate one or more third parties 500 when running a real estate transaction management software system 200 driven by artificial intelligence (AI). There are many occasions where each player needs to communicate with other players. In this regard, the platform provides one or more communication functionalities with a high/reliable security level. (See FIG. 6.) Traditionally, when buyers and sellers need to communicate with their trusted advisors and other players, they make a phone/video call or send a text message. That means they need to use different applications (e.g., text messaging apps, calling apps, video chatting or conferencing apps, etc.). Instead of looking for suitable communication applications, the platform provides communication functionalities 602 so that users as buyers, sellers, agents, etc. may be able to communicate with each other without leaving the platform. The communication may be textual, audio, or video and all the communications may be saved in the platform so that the users can track the chain of communications with each other.

In a case where sellers want to sell their houses by themselves, they can also find all resources on the platform. They can find a list of photographers who are experts in taking real estate pictures to enable sellers to create an eye-catching presentation of the house for sale. Further, the buyers may upload descriptions, photos, multimedia, etc. about the house to the platform, which in turn uploads to other real estate websites (e.g., zillow.com, trulia.com, local real estate websites, etc.). In this way, the buyers do not have to upload the multimedia content to each real estate website and to format the content according to the requirements of each website. Likewise, the listing agents do not have to upload the content to every single real estate website, but rather upload the content once to the platform, which in turn uploads the content to the various real estate websites. (See the left screen shot in FIG. 10.)

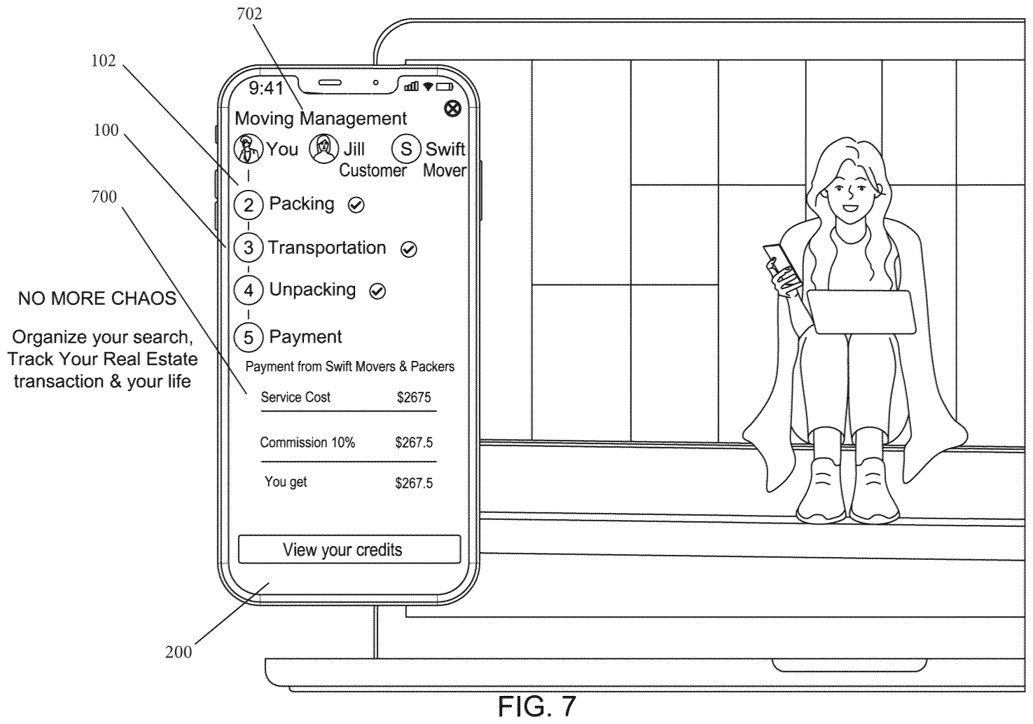

Traditionally, buyers need to visit each real estate website and may be able to find the same house on several websites, which means they waste their time looking at the same house in different locations. Also, some local or agent specific broker's real estate websites may have a list of houses for sale, which are not found in other websites, including the major real estate websites (e.g., zillow.com, trulia.com). This means that buyers must visit each of these websites to make sure they do not miss any house for sale, which may be their dream home. To address this, the AI of the platform retrieves information from each real estate website, sorts and processes the data, and provides a combined list of real estate for sale without any duplication in a user-friendly format. In this regard, the platform may be connected to servers of each real estate website and able to retrieve and aggregate listing information from each website. (See FIGS. 7 and 8.) The platform may regularly update the combined list or update the list such upon manual request from the users or automatically.

This platform utilizes an AI system configured to gather data from various real estate websites. Once collected, this data is organized and processed to generate a unified list of available properties for sale, ensuring that duplicates are removed. The resulting list is presented in a format that is easy for users to navigate and understand. To achieve this, the platform is designed to establish connections with the servers of each real estate website. This allows it to retrieve and consolidate listing information from each of these sources. The platform also has the capability to routinely update the combined list, ensuring that users are provided with the most current information about available properties. Additionally, users have the option to manually request updates to the list. Alternatively, the platform is equipped to automatically refresh the information based on predefined intervals or triggers. This platform leverages AI technology to streamline the process of accessing real estate listings. By connecting to multiple real estate websites, it compiles and maintains a comprehensive, up-to-date list of properties for sale, offering users a convenient and efficient way to explore available options in the real estate market.

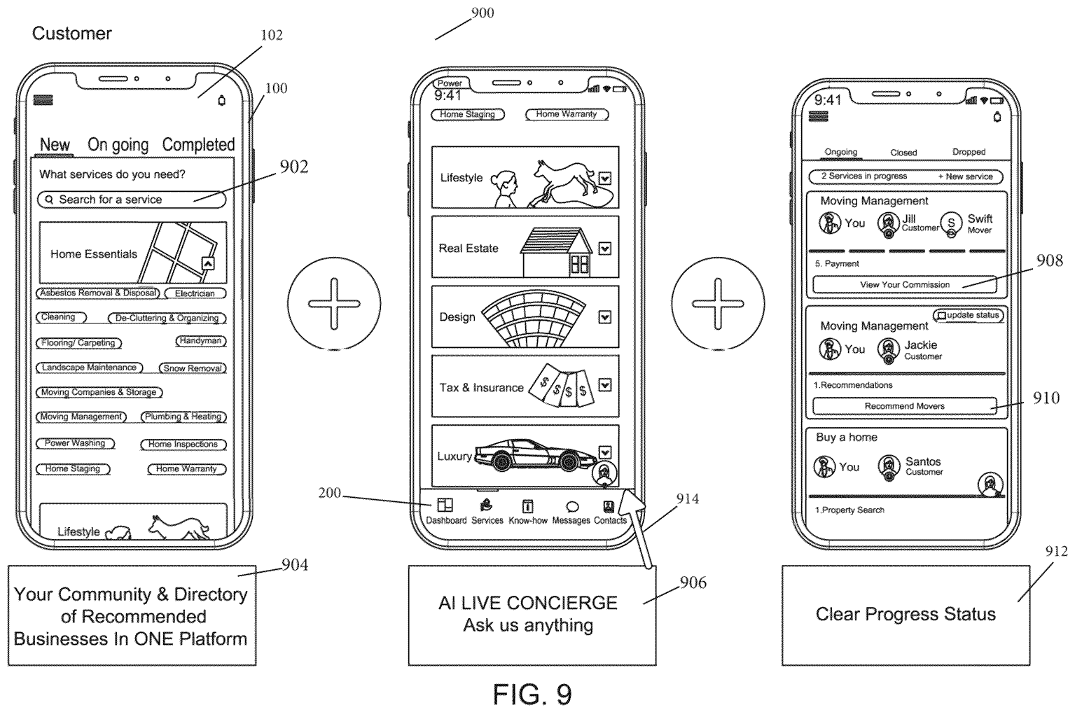

FIG. 7 illustrates a display 102 of an electronic device 100 showing operational sequence 700 that may be performed to conduct moving management 702 when running a real estate transaction management software system 200 driven by artificial intelligence (AI). The platform further provides a list of management companies, which manages rental properties, moving, or repairs. Owners of rental properties may contact a management company to request a management service of one or more rental properties and the management company manages starting and end of leases, advertises the rental properties to find and interview potential tenants, goes through credit reports, arranges handymen to address issues raised by tenants with the owner's approval, collects rents, and disburses the collected rents to the owner after deduction of management fees and related fees. In this regard, the platform may provide a user interface, through which owners/buyers/sellers/agents may be able to see incomes and expenses from rents, purchases/sales, commissions, etc. at on page (See the right screen shot in FIGS. 9 and 10.).

This platform provides a user with a comprehensive service for rental property owners, for example, connecting them with management companies, in an example, that may handle various aspects of property management, including rental, moving, and repairs. To name a few, some of the services provided include, but are not limited to:

1. List of Management Companies: The platform may provide a directory of management companies that specialize in managing rental properties, which includes services including, but not limited to, a lease management, a tenant screening, and/or maintenance.
2. Requesting Management Services: Property owners may contact a management company, for example, through the platform to request services for one or more of their rental properties.
3. Lease Management: The management company takes charge of the entire leasing process, from the start to the end of leases.
4. Tenant Screening: They advertise the rental properties and screen potential tenants, which may involve tasks like conducting interviews and reviewing credit reports.
5. Maintenance Coordination: The management company arranges for handymen to address tenant-reported issues, always with the owner's approval.
6. Rent Collection and Disbursement: The collection of rents and distribution of the collected rents are to the owner after deducting management fees and related expenses.

Regarding the user interface, the platform provides an intuitive interface for users including, but not limited to, owners, buyers, sellers, and-'or agents. This interface allows them to easily track their financial transactions and activities related to their properties. This includes information abort rental income, expenses from purchases and sales, as well as any associated commissions. All this information is conveniently accessible on a single page, providing a clear overview of their financials. Overall, this platform streamlines property management by connecting property owners with experienced management companies and offering a user-friendly interface to monitor financial activities related to their properties.

FIG. 9 illustrates a display 102 of an electronic device 100 showing operational sequence 900. At step 902, a user may search for a service within community and directory database 904 from a plurality of sources when running a real estate transaction management software system 200 driven by artificial intelligence (AI). AI live concierge 906 is configured to provide access to 914 solutions and/or answers to asked questions. The ability to monitor and track progress of a transaction is an important aspect of this invention. For example, at step 908 a user may view commission, at step 910 a user may recommend a service provider, and at step 912 a user may clear progress status.

FIG. 10 illustrates a display 102 of an electronic device 100 showing operational sequence 1000. At step 1002, a user may search bookmarks for available property listings 1004 from a plurality of sources 1006 when running a real estate transaction management software system 200 driven by artificial intelligence (AI). At step 1008, a user's selected listings from all aggregators are directed to and accessible from one platform. At step 1010, a user may search messages from a contact list 1012. At step 1014, a user's community of vetted businesses are directed to and accessible by the user from a directory in one platform. At step 1016, agents' compensation may be updated by AI from providers and displayed to a user. User data and/or information such as, payment information 1022 is protected 1018 with security measures such as, an authentication alphanumeric password 1020. Additionally, the platform provides a directory of vetted businesses in the user's community, so that the users can find businesses in their communities without leaving the platform. (See the middle screenshot in FIG. 10.) Further, the users may be able to make a call, send a text message, or even set up video conferencing with businesses, which suits their needs, through the platform.

Additionally, the platform provides accessory services, such as a lifestyle guide, basics about real estate, design suggestions for colors of paint, information about taxes and insurance, and information about luxury items. (See the middle screenshot in FIG. 9.) Users may access these services by clicking through menus or by orally or verbally asking the platform for such services. The AI engine of the platform may be equipped with natural language processing so that the AI engine provides adequate/proper responses to the users' oral requests. (See the left screen shot in FIG. 9.)

The AI engine may be a machine learning algorithm, which is trained by supervised, unsupervised, semi--supervised, or a reinforced manner or any combination thereof.

The platform may provide communication capabilities between anyone in the system. In particular, the platform shows a concierge button, through which the AI engine provides an instant response to any user. For example, when a client (e.g., a buyer or seller) needs help, the client may push or click the concierge button, and the corresponding agent may be pinged to cause the agent to respond to the client. In a case where the agent is not able to respond to the client's request within a set time (e.g., two minutes), an AI chat hot implemented by the AI engine responds to the client's request. In another case where the AI cat bot is unable to address the client's request, a live concierge customer service representative jumps on the line.

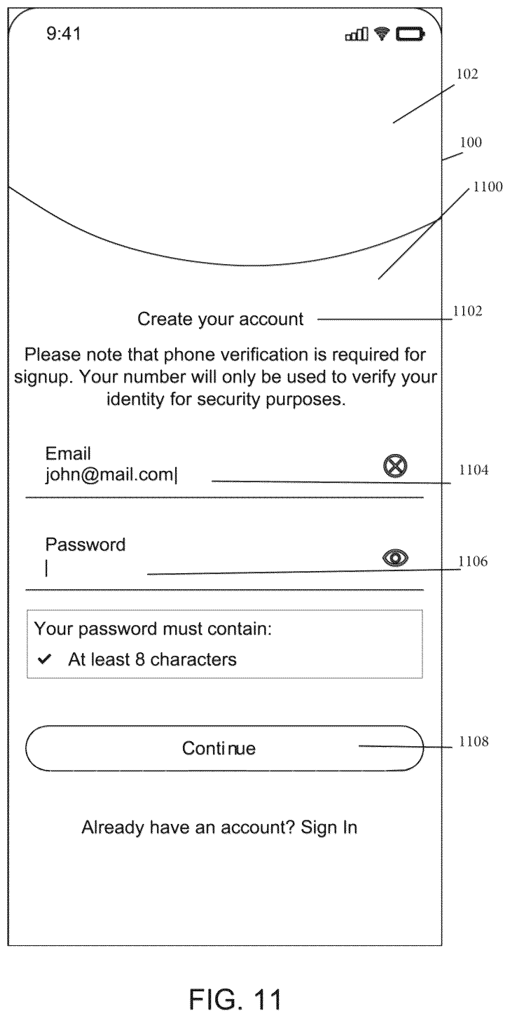

FIG. 11 illustrates a display 102 of an electronic device 100 showing operational sequence 1100. At step 1102. a user may create an account when running a real estate transaction management software system driven by artificial intelligence (AI). At step 1104 a user inputs an email address. At step 1106, a user inputs a password. At step 1108, a user selects continue to submit the login credentials to the system.

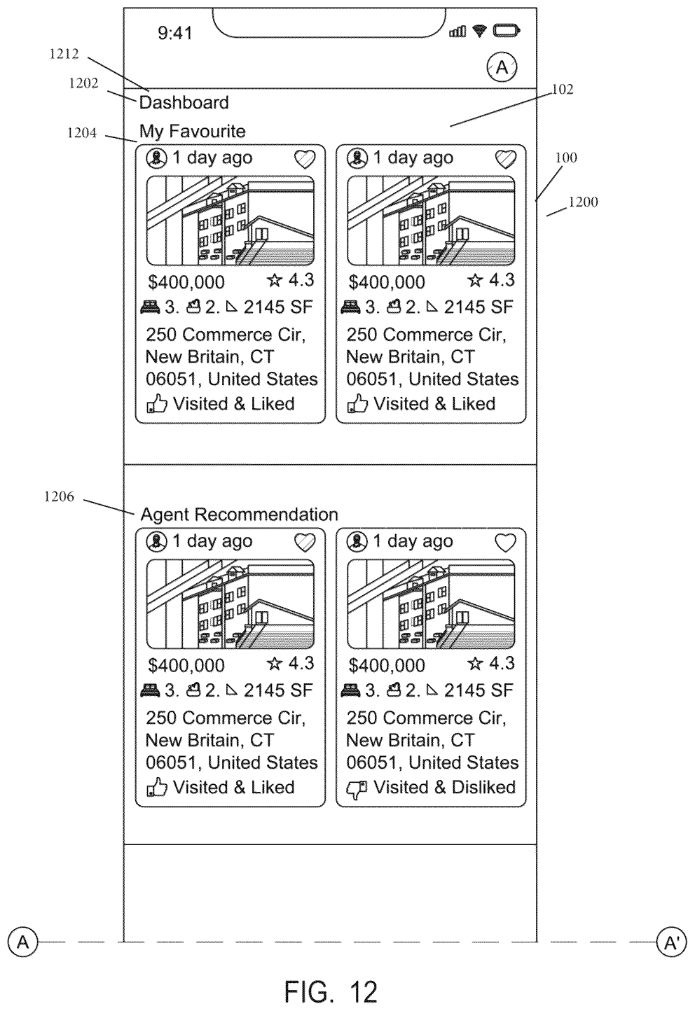

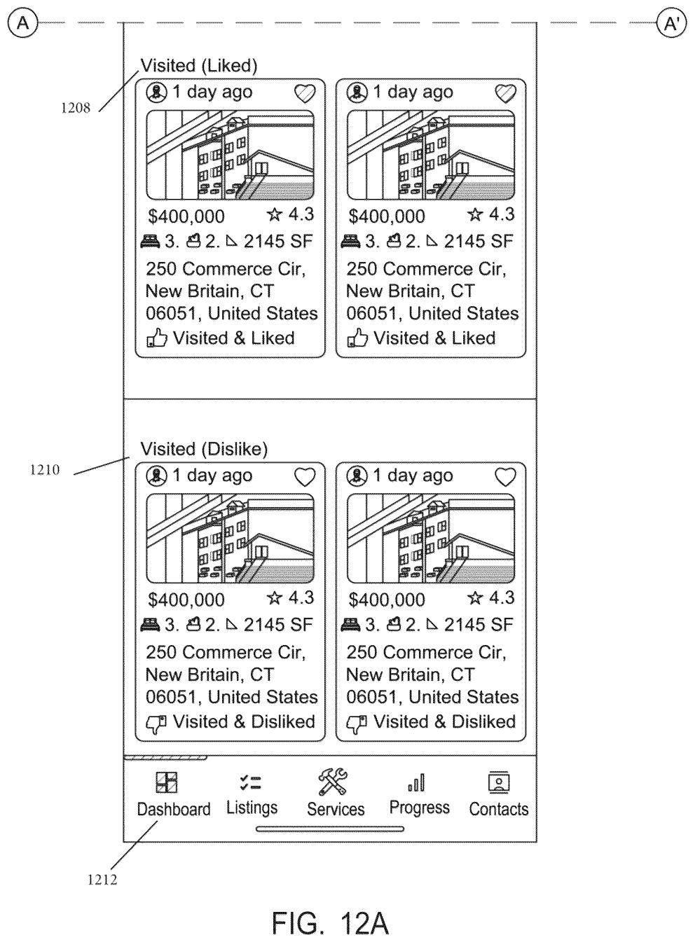

FIG. 12 illustrates a display 102 of an electronic device 100 showing operational sequence 1200. At step 1202. a user may access a dashboard 1212 when running a real estate transaction management software system driven by artificial intelligence (AI). At step 1204, a user may access favorite properties. At step 1206, a user may access agent recommendations that are displayed in the graphic user interface of the display of the electronic device. FIG. 12A shows at step 1208, a user may access a visited and/or liked page. At step 1210, a user may access a visited and/or disliked page.

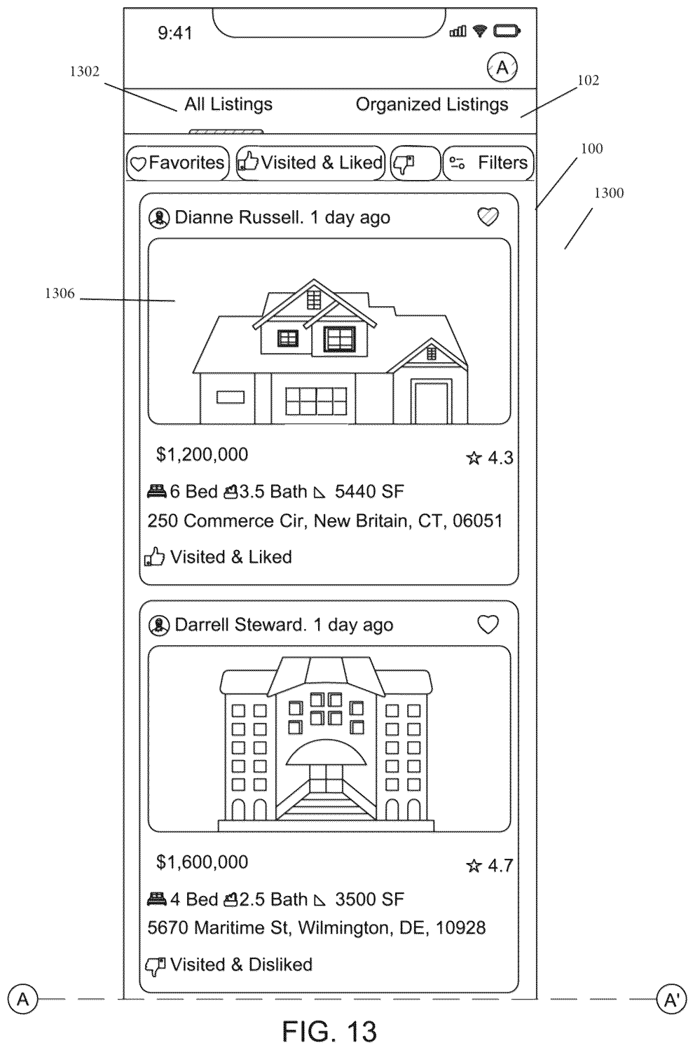

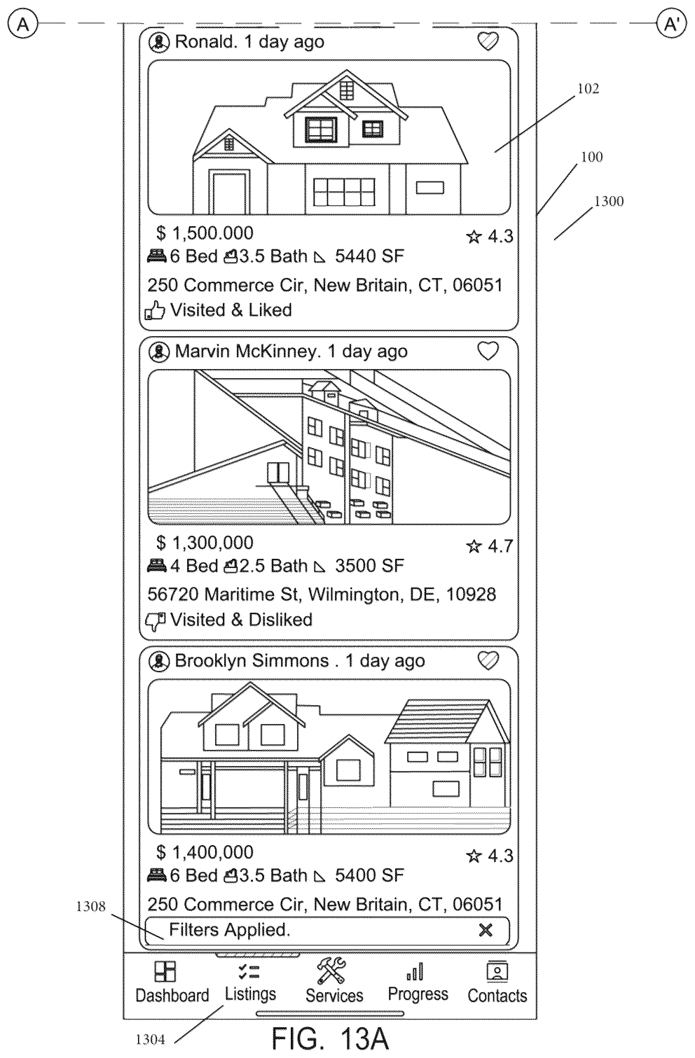

FIG. 13 illustrates a display 102 of an electronic device 100 showing operational sequence 1300. At step 1302, a user may access all listings from a listings tab 1304 (FIG. 13A) when running a real estate transaction management software system driven by artificial intelligence (AI). One or more property listings 1306 and their associated details and descriptions may be displayed to a user. At step 1308, a filter may be applied to search for a specific type of property.

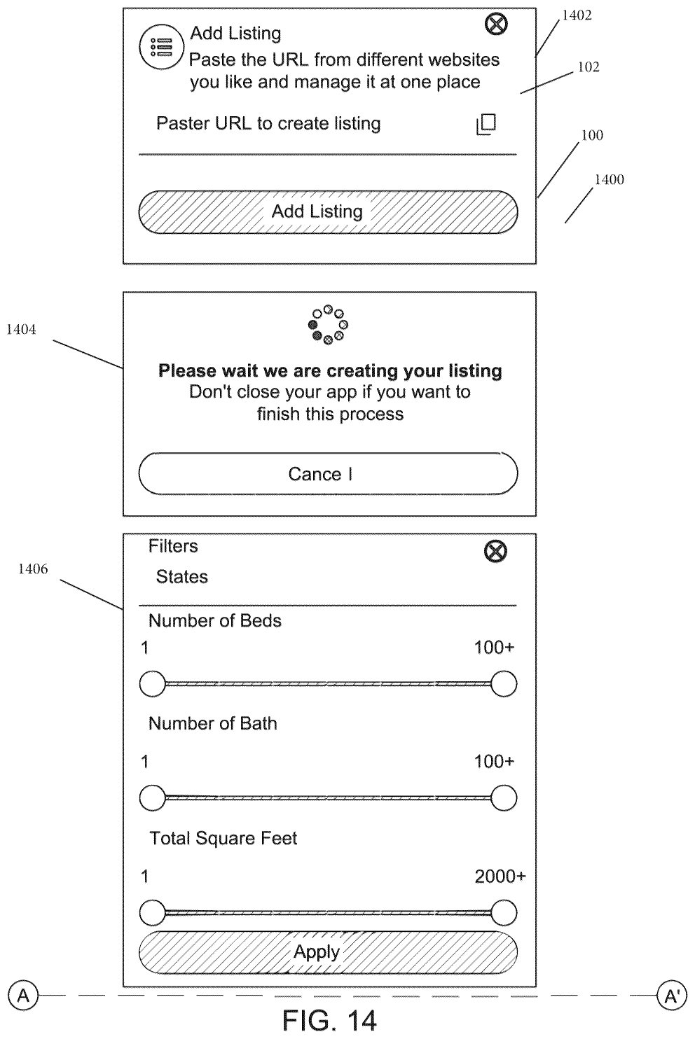

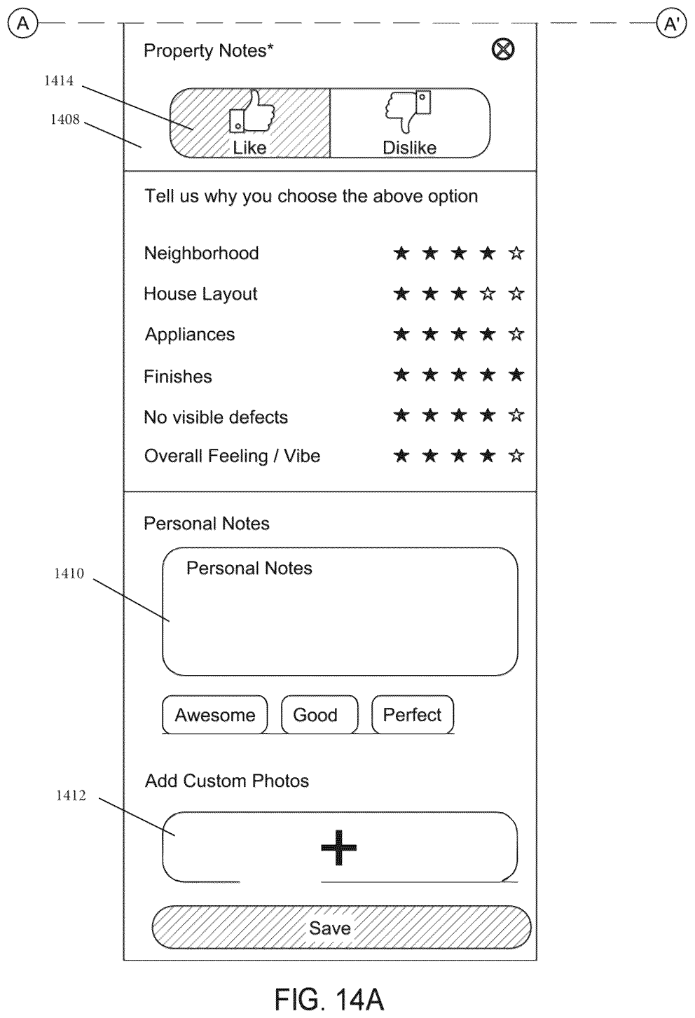

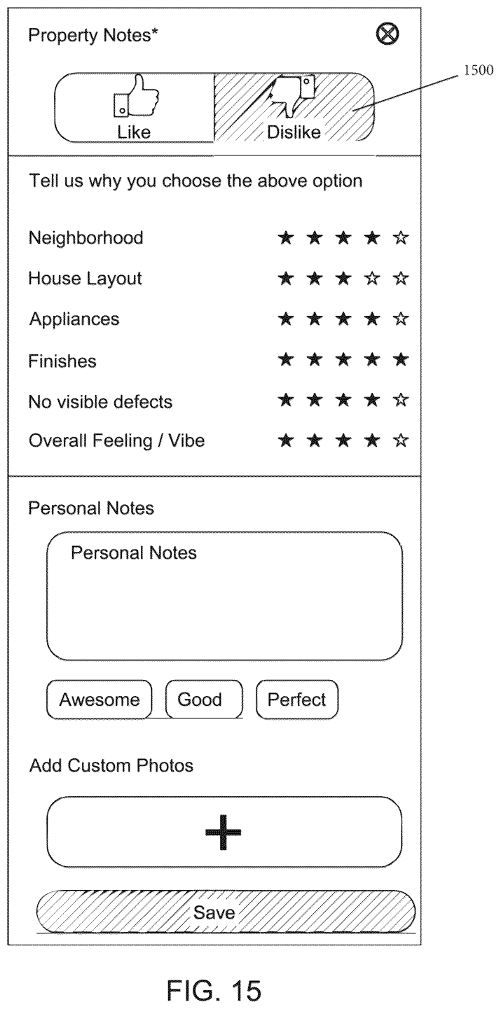

FIG. 14 illustrates a display 102 of an electronic device 100 showing operational sequence 1400. At step 1402, a user may add a listing by pasting the URL from different websites and manage the listing from the platform. At step 1404, a listing will be created based on URL input by the user into the system. At step 1406, a user may input filters to specify the number of bedrooms, bathrooms, and/or square feet a home is required to have, to name a few examples. FIG. 14A best shows step 1408 allowing a user to input feedback directed to the property such as, selecting a like icon 1414 or a dislike icon 1500 (FIG. 15). At step 1410. personal notes may be input into the system. At step 1412, custom photos may be added to the system by a user.

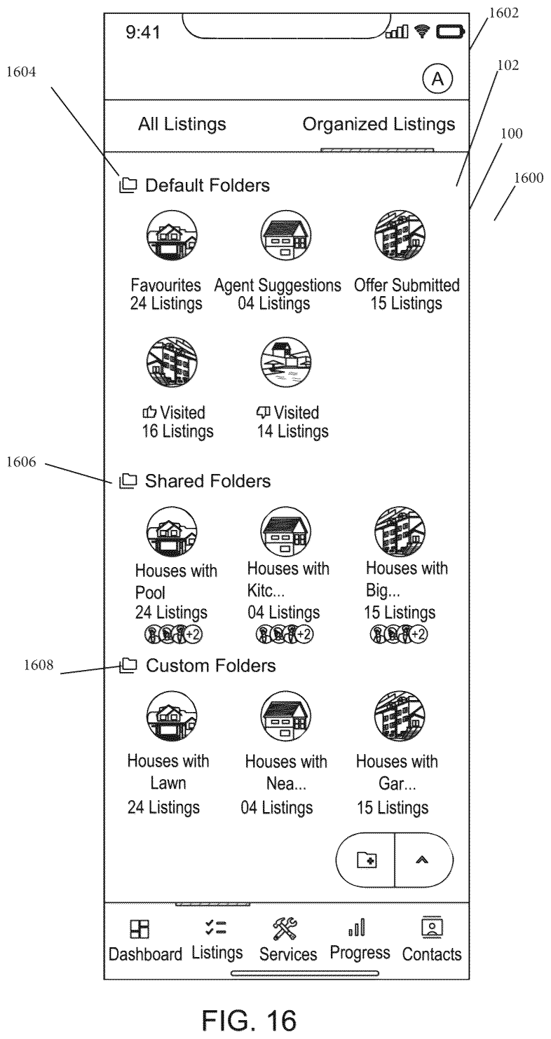

FIG. 16 illustrates a display 102 of an electronic device 100 showing operational sequence 1600. At step 1602, listings may be organized into default folders 1604, shared folders 1606, and/or custom folders 1608, to name a few examples.

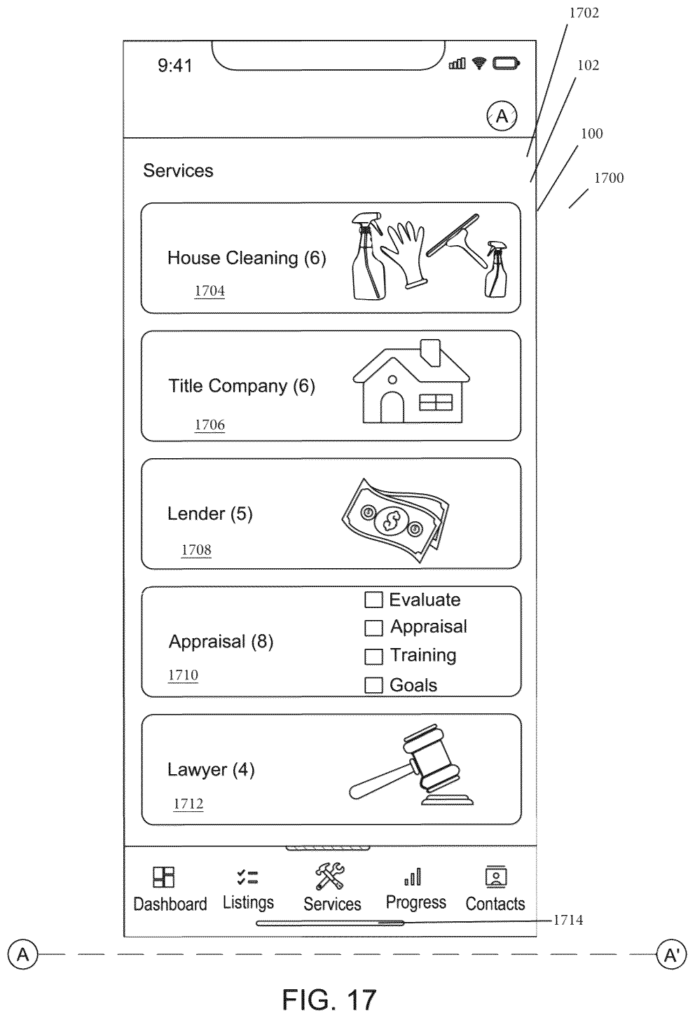

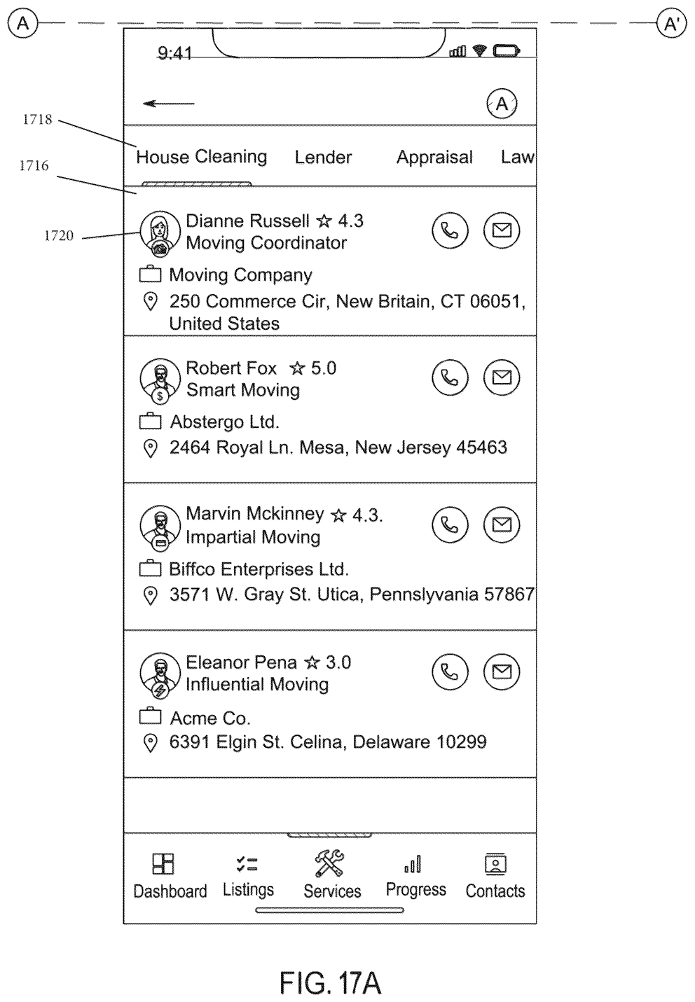

FIG. 17 illustrates a display 102 of an electronic device 100 showing operational sequence 1700. At step 1702, a listing of services, from a services tab 1714, are displayed to a user including, but not limited to, house cleaning 1704, a tile company 1706, a lender 1708, appraisal companies 1710, and/or lawyers 1712 to name a few. In an example shown in FIG. 17A, at step 1716, the house cleaning tab 1718 is selected by a user and one or more service providers 1720 are displayed to a user.

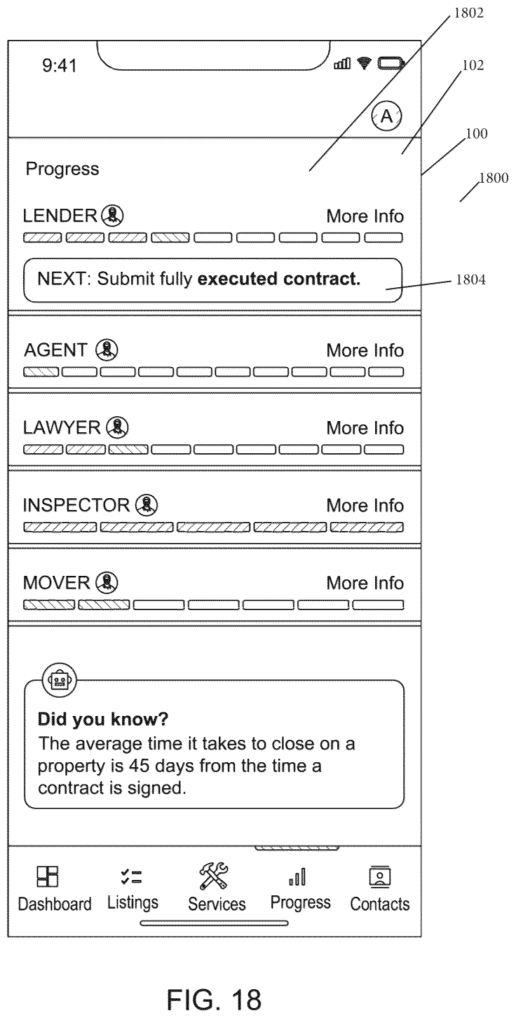

FIG. 18 illustrates a display 102 of an electronic device 100 showing operational sequence 1800. At step 1802, progression of a lender transaction is displayed to a user. For example, at step 1804 the next step of a lender process is displayed to a user as being for a user to submit a fully executed contract.

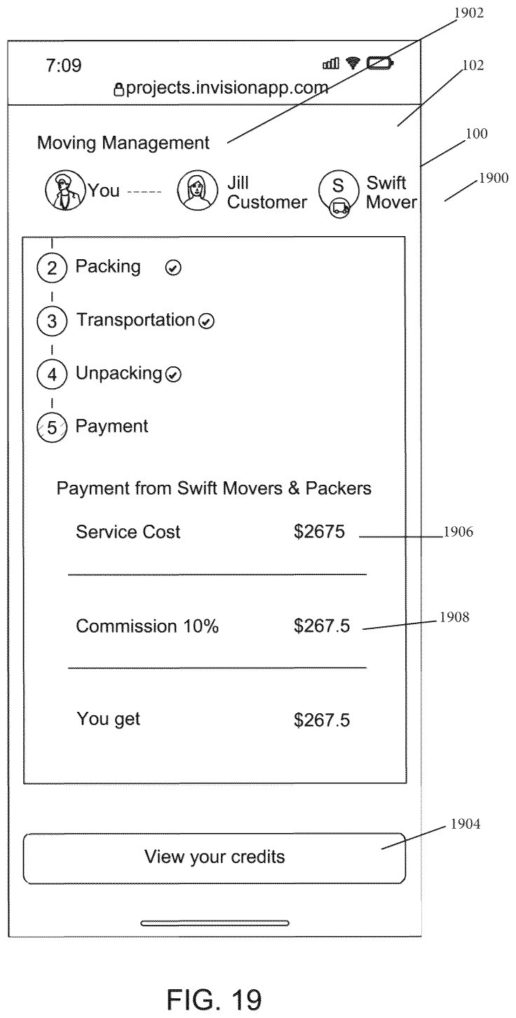

FIG. 19 illustrates a display 102 of an electronic device 100 showing operational sequence 1900. At step 1902, a moving management page is displayed to a user with a checklist for packing, transportation, unpacking, and payment, to name a few examples. At step 1904. accumulated credits may be viewed, At step 1906, the cost for services rendered may he displayed. At step 1908, commission may also be calculated and displayed to a user.

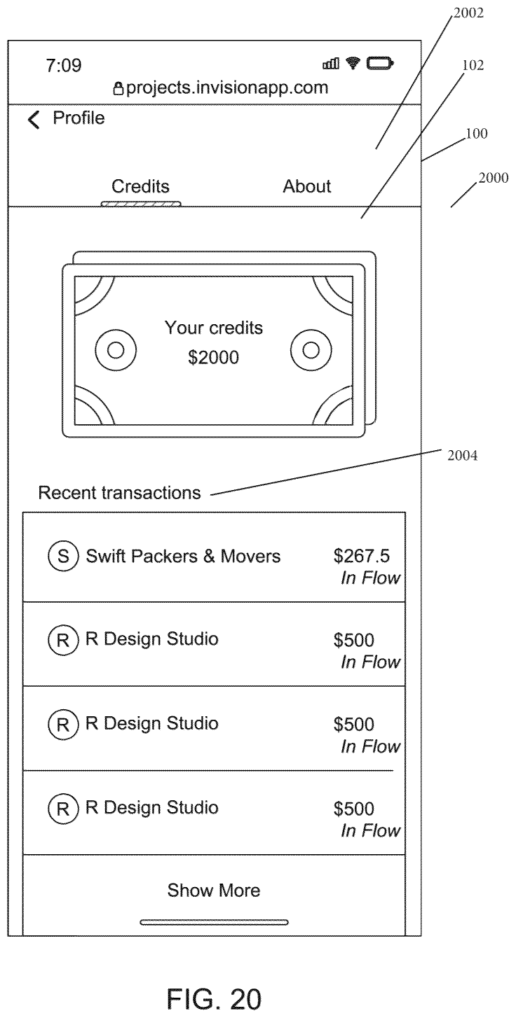

FIG. 20 illustrates a display 102 of an electronic device 100 showing operational sequence 2000. At step 2002, an agent, for example, may track all referral fees from multiple service providers. In particular, step 2004 shows credits from recent transactions that may be displayed to a user.

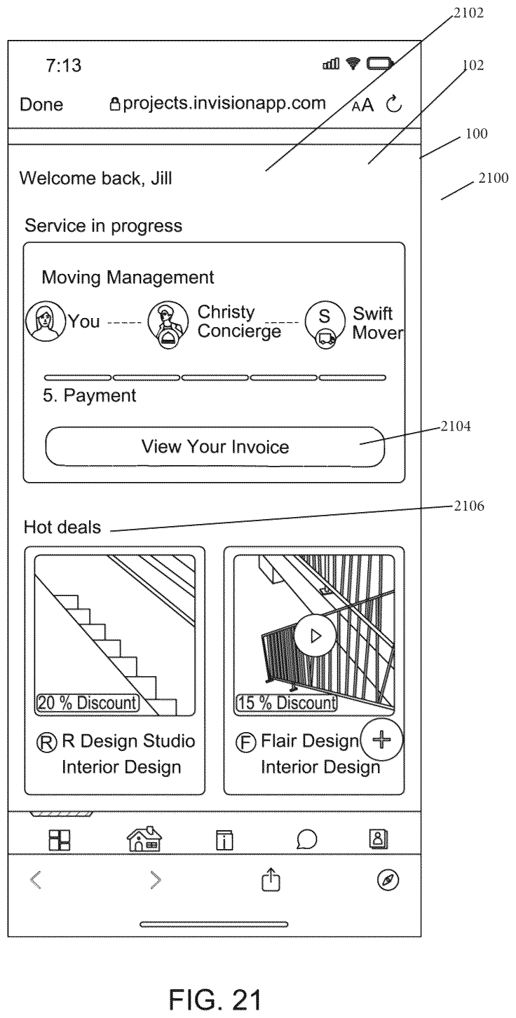

FIG. 21 illustrates a display 102 of an electronic device 100 showing operational sequence 2100. At step 2102, the services in progress will be displayed to a user. In an example, an existing transaction being moving management is shown to be in the payment stage. A customer may be prompted to make payments for the service providers in the App. At step 2104, a user may view an invoice. At step 2106, a user may view offers from service providers.

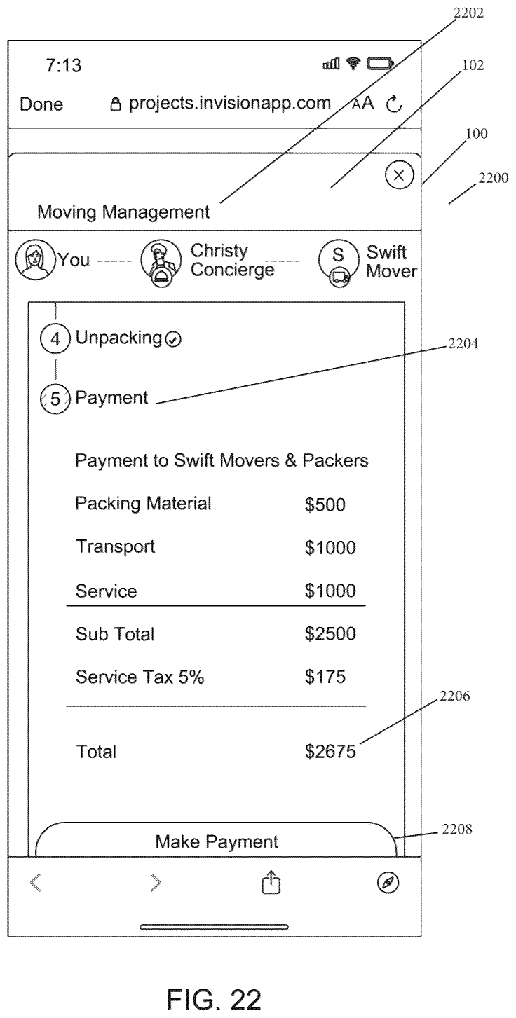

FIG. 22 illustrates a display 102 of an electronic device 100 showing operational sequence 2200. At step 2202, the services in progress are displayed to a user for moving management. In an example, step 2204 the checklist shows that the unpacking process has been completed and that the payment step is pending. At step 2206, an invoice is generated by the system and displayed to a user. At step 2208, a user may select to make a payment.

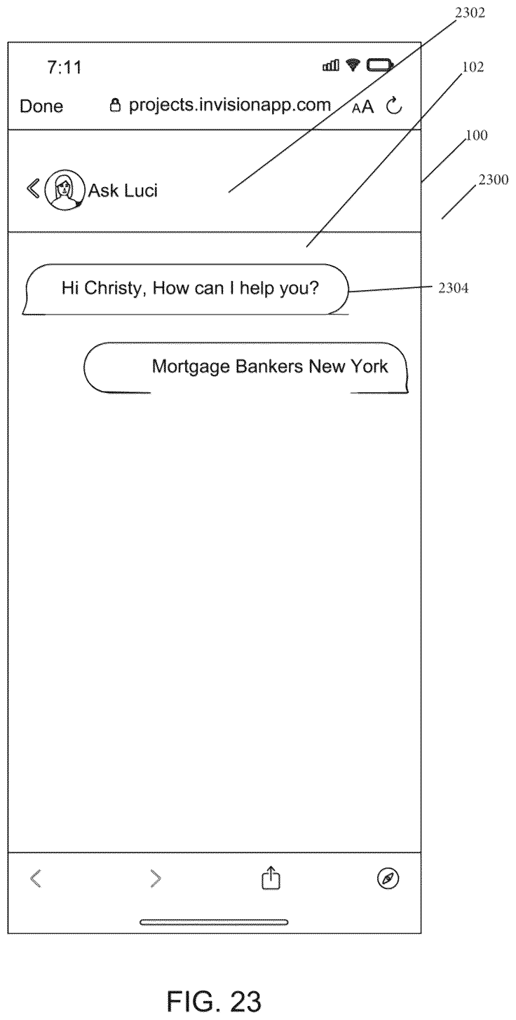

FIG. 23 illustrates a display 102 of an electronic device 100 showing operational sequence 2300. At step 2302, a user may input a question into the system's chat room. At step 2304, a representative may communicate with the user by responding to the question with an answer. In particular, with the AI, clients may ask any thing relating to their transactions and they will receive a response.

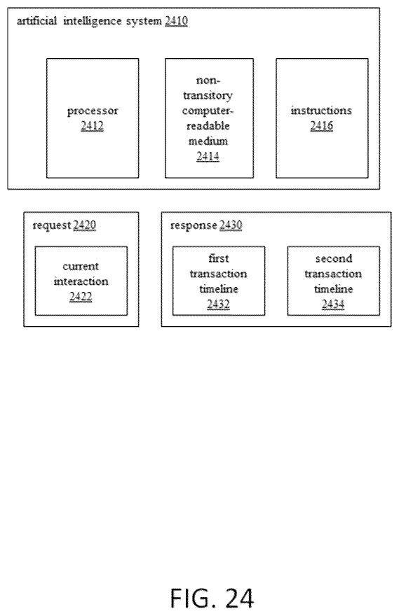

FIG. 24 is a block diagram that describes an artificial intelligence system 2410, according to some embodiments of the present disclosure. In some embodiments, the artificial intelligence system 2410 may include a processor 2412, a non-transitory computer-readable medium 2414 executing instructions 2416 including authenticating a user in a system search module, responsive to authenticating, initializing the system search module executing on an electronic device, receiving a request 2420 from the system search module at the electronic device, determining one or more transactions for one or more real estate properties for sale or one or more transactions for one or more third party service providers from the request 2420 from the system search module.

In some embodiments, instructions 2416 include formulating a response 2430 to the request 2420 that includes providing aggregated content related to the one or more transactions for the one or more real estate properties for sale or the one or more transactions for the one or more third party service providers from the current login session. Instructions 2416 may include sending the formulated response to the system search module to be displayed on the electronic device. The request 2420 may include a current interaction 2422 entered by the user in a graphic user interface portion of a touch driven interface displayed at the electronic device.

In some embodiments, the request 2420 may represent at least a portion of a current login session with the user. The response 2430 may include a first transaction timeline 2432 for a first list of the one or more transactions for the one or more real estate properties for sale and a second transaction timeline 2434 for a second list of the one or more transactions for the one or more third party service providers. The response 2430 may be associated with the current login session associated with the user.

In some embodiments, the AI engine 2514 may be a machine learning algorithm that may be trained by at least one supervised, unsupervised, semi-supervised, or a reinforced manner. In some embodiments, the non-transitory computer-readable medium has instructions 2416 for providing accessory services, the accessory services being a lifestyle guide, basics about real estate, design suggestions for colors of paint, or information about taxes and insurance, or luxury items.

In some embodiments, the artificial intelligence system 2410 may also include a document repository, the document repository configured to retain one or more documents associated with the first transaction timeline 2432 or the second. transaction timeline 2434. In some embodiments, the aggregated content may be provided by an AI document automation system, the AI document automation system generating one or more documents coupled to a compliance and regulatory system based on a location of a first transaction of the one or more transactions or a second transaction of the one or more transactions from the request 2420 from the system search module.

In some embodiments, the non-transitory computer-readable medium. Providing communication between a first entity and a second entity associated with the one or more transactions for the one or more real estate properties for sale or the one or more transactions for the one or more third party service providers from the request 2420 from the system search module. In some embodiments, the non-transitory computer-readable medium. Providing financial payment transactions between a first entity and a second entity associated with the one or more transactions for the one or more real estate properties for sale or the one or more transactions for the one or more third party service providers from the request 2420 from the system search module.

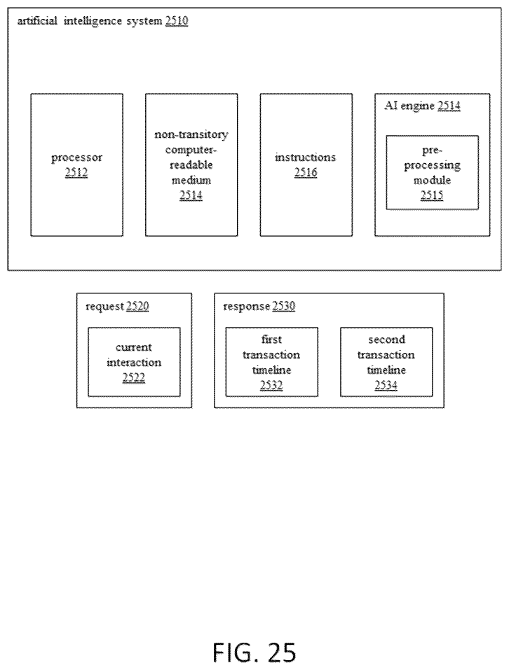

FIG. 25 is a block diagram that further describes the artificial intelligence system 2410 from FIG. 24, according to some embodiments of the present disclosure. In some embodiments, the artificial intelligence system 2410 may also include an AI engine 2514, the AI engine 2514 determining the one or more transactions for the one or more real estate properties for sale or the one or more transactions for the one or more third party service providers from the request 2420 from the system search module. In some embodiments, the AI engine 2514 may include a pre-processing module 2515 that receives the request 2420 and the current login session and creates the first transaction timeline 2432 for the first list of the one or more transactions for the one or more real estate properties for sale or the second transaction timeline 2434 for the second list of the one or more transactions for the one or more third party service providers.

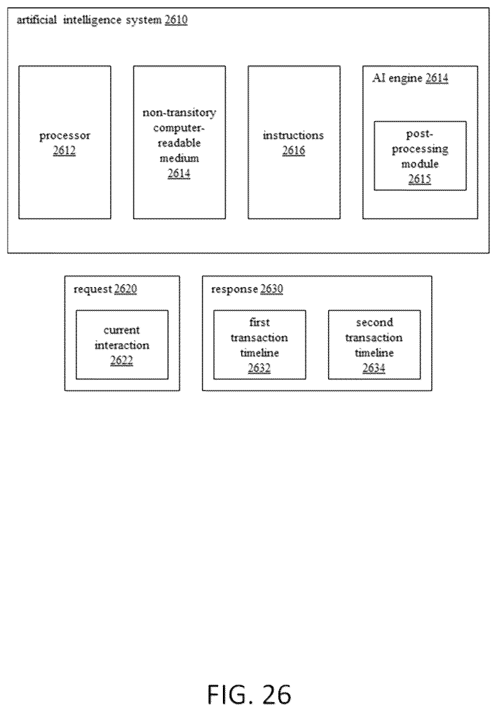

FIG. 26 is a block diagram that further describes the artificial intelligence system 2410 from FIG. 24, according to some embodiments of the present disclosure. In some embodiments, the artificial intelligence system 2410 may also include an AI engine 2514, the AI engine 2514 determining the one or more transactions for the one or more real estate properties for sale or the one or more transactions for the one or more third party service providers from the request 2420 from the system search module. In some embodiments, the AI engine 2514 may include a post-processing module 2615 that monitors and updates a progression status for the first transaction timeline 2432 for the first list of the one or more transactions for the one or more real estate properties for sale or the second transaction timeline 2434 for the second list of the one or more transactions for the one or more third party service providers for each subsequent login session.

The pre-processing module 2515 and/or the post-processing module 2615, and/or any other component of the AI engine is configured be communicatively coupled to data, the data including, but not limited to, a customer profile and/or one or more outside sources. In particular, data is input into a component of the AI engine. As a result, a component of the AI engine may output, to a display of an electronic device, facts about horde purchasing and/or predicting a subsequent step in process for a property transaction process.

For example, this disclosure describes a system and/or software application that involves an AI engine with pre-processing and post-processing modules, as well as other components. These components are designed to interact with data, which can include a customer profile and information from external sources. The primary function of this system is to take input data and process it through the AI engine. This processing can lead to the generation of information related to home purchasing, as well as predictions about the next steps in the property transaction process. Specifically, the information generated by the AI engine can be displayed on an electronic device, providing users with insights and predictions related to property transactions. This may provide a useful means in real estate and/or related industries where understanding customer profiles and predicting future steps in the buying/selling process are critical. This system is configured to be designed to assist individuals and/or professionals involved in property transactions by leveraging AI and data analysis to provide valuable insights and predictions.

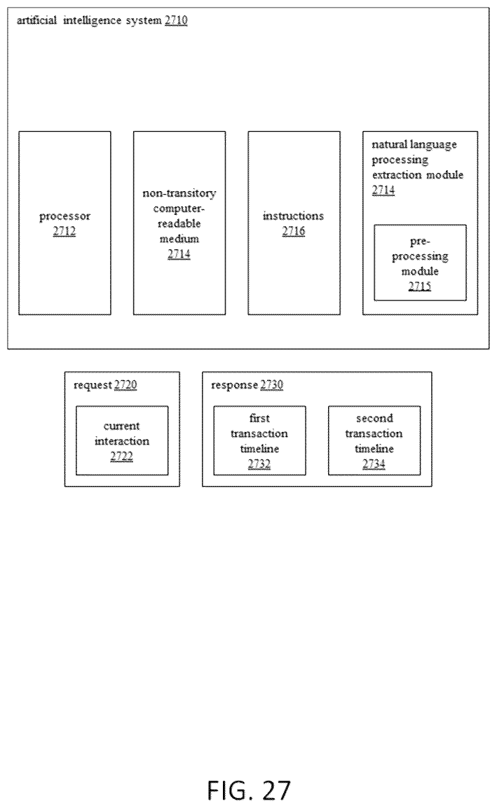

FIG. 27 is a block diagram that further describes the artificial intelligence system 2410 from FIG. 24, according to some embodiments of the present disclosure. In some embodiments, the artificial intelligence system 2410 may include a natural language processing extraction module 2714 determining the one or more transactions for the one or more real estate properties for sale or the one or more transactions for the one or more third party service providers from the request 2420 from the system search module. In some embodiments, the natural language processing extraction module 2714 may include a pre-processing module 2715 that receives the request 2420 and the current login session and creates the first transaction timeline 2432 for the first list of the one or more transactions for the one or more real estate properties for sale or the second transaction timeline 2434 for the second list of the one or more transactions for the one or more third party service providers.

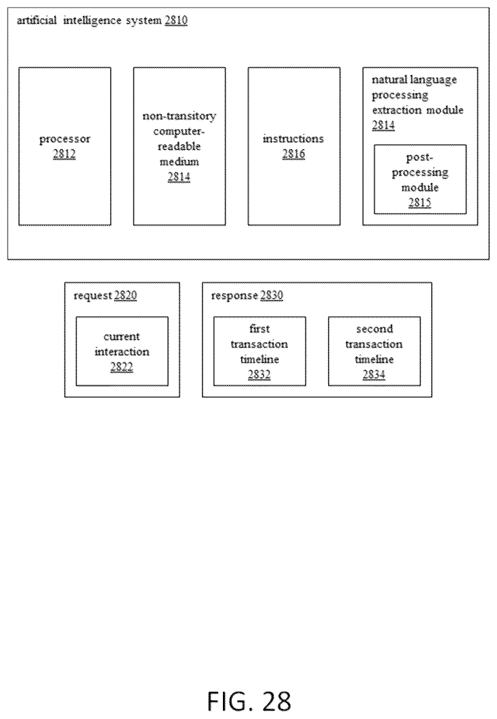

FIG. 28 is a block diagram that further describes the artificial intelligence system 2410 from FIG. 24, according to some embodiments of the present disclosure. In some embodiments, the artificial intelligence system 2410 may include a natural language processing extraction module 2714 determining the one or more transactions for the one or more real estate properties for sale or the one or more transactions for the one or more third party service providers from the request 2420 from the system search module. In some embodiments, the natural language processing extraction module 2714 may include a post-processing module 2815 that monitors and updates a progression status for the first transaction timeline 2432 for the first list of the one or more transactions for the one or more real estate properties for sale or the second transaction timeline 2434 for the second list of the one or more transactions for the one or more third party service providers for each subsequent login session.

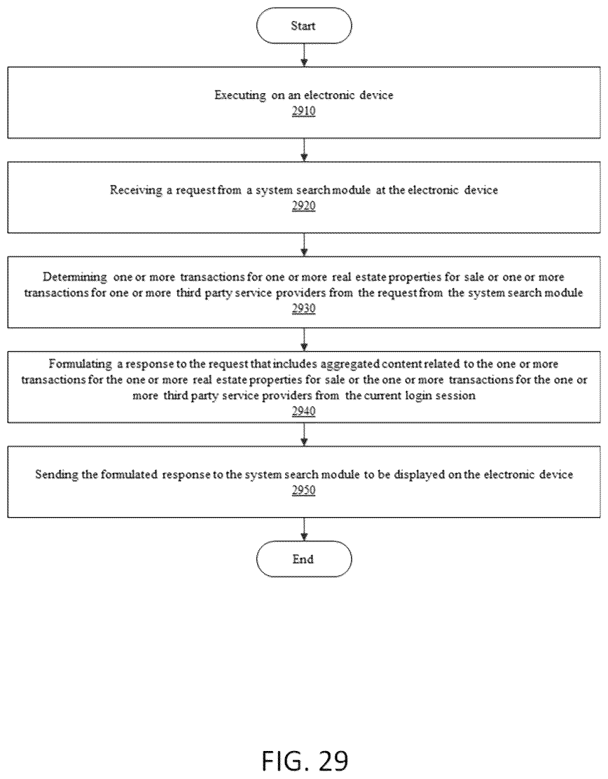

FIG. 29 is a flowchart that describes a computer-implemented method, according to some embodiments of the present disclosure. In some embodiments, at 2910, the computer-implemented method may include executing on an electronic device. At 2920, the computer-implemented method may include receiving a request from a system search module at the electronic device. At 2930, the computer-implemented method may include determining one or more transactions for one or more real estate properties for sale or one or more transactions for one or more third party service providers from the request from the system search module.

In some embodiments, at 2940, the computer-implemented method may include formulating a response to the request that includes aggregated content related to the one or more transactions for the one or more real estate properties for sale or the one or more transactions for the one or more third party service providers from the current login session. At 2950, the computer-implemented method may include sending the formulated response to the system search module to be displayed on the electronic device.

In some embodiments, the request may include a current interaction entered by a user in a graphic user interface portion of a touch driven interface displayed at the electronic device. The request may represent at least a portion of a current login session with the user. The response may include a first transaction timeline for a first list of the one or more transactions for the one or more real estate properties for sale or a second transaction timeline for a second list of the one or more transactions for the one or more third party service providers. The response may be associated with the current login session associated with the user.

In some embodiments, an AI engine, the AI engine determining the one or more transactions for the one or more real estate properties for sale or the one or more transactions for the one or more third party service providers from the request from the system search module, and the AI engine may be a machine learning algorithm that may be trained by at least one supervised, unsupervised, semi-supervised, or a reinforced manner.

In some embodiments, the AI engine may include, the computer-implemented method may include performing one or more additional steps. A pre-processing module that receives the request and the current login session and creates the first transaction timeline for the first list of the one or more transactions for the one or more real estate properties for sale or a second transaction timeline for the second list of the one or more transactions for the one or more third party service providers. A post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

In some embodiments, a natural language processing extraction module may determine the one or more transactions for the one or more real estate properties for sale or the one or more transactions for the one or more third party service providers from the request from the system search module. In some embodiments, the natural language processing extraction module may include, the computer-implemented method may include performing one or more additional steps. A pre-processing module that receives the request and the current login session and creates the first transaction timeline for the first list of the one or more transactions for the one or more real estate properties for sale or the second transaction timeline for the second list of the one or more transactions for the one or more third party service providers. A post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

In some embodiments, the method may include providing communication between a first entity and a second entity associated with the one or more transactions for the one or more real estate properties for sale or the one or more transactions for the one or more third party service providers from the request from the system search module. In some embodiments, the method may include providing financial payment transactions between a first entity and a second entity associated with the one or more transactions for the one or more real estate properties for sale or the one or more transactions for the one or more third party service providers from the request from the system search module.

The present disclosure can be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described features and/or that includes one or more circuits (e.g., application specific integrated circuit (ASIC) for performing the functions of one or more of the above-described features, and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), field programmable gate array (FPGA), digital signal processor (DSP), data flow processor (DFP), neural processing unit (NPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (Balm), a flash memory device, a memory card, and the like.

While the present disclosure has been described with reference to exemplary embodiments, it is to be understood that the disclosure is not limited to the disclosed exemplary embodiments.

It is to be appreciated that the Detailed Description section in addition to the Summary and Abstract sections, is intended to be used to interpret the claims. The Summary and Abstract sections may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. Further, embodiments (whether or not explicitly described herein) have significant utility to fields and applications beyond the examples described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant arts) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

Now that the invention has been described.

What is claimed is:

1. An artificial intelligence system for real estate transaction management, comprising:
a processor; and
a non-transitory computer-readable medium comprising instructions for:
authenticating a user in a system search module;
responsive to authenticating, initializing the system search module executing on an electronic device;
receiving a request from the system search module at the electronic device, wherein the request includes a current interaction entered by the user in a graphic user interface portion of a touch driven interface displayed at the electronic device, and wherein the request represents at least a portion of a current login session with the user;
determining one or more transactions for one or more real estate properties for sale or one or more transactions for one or more third party service providers from the request from the system search module;
formulating a response to the request that includes aggregated content related to the one or more transactions for the one or more real estate properties for sale or the one or more transactions for the one or more third party service providers from the current login session; and
sending the formulated response to the system search module to be displayed on the electronic device, wherein the response includes a first transaction timeline for a first list of the one or more transactions for the one or more real estate properties for sale or a second transaction timeline for a second list of the one or more transactions for the one or more third party service providers and wherein the response is associated with the current login session associated with the user.

2. The system of claim 1, further comprising:
an AI engine, the AI engine determining the one or more transactions for the one or more real estate properties for sale or the one or more transactions for the one or more third party service providers from the request from the system search module.

3. The system of claim 2, wherein the AI engine is a machine learning algorithm that is trained by at least one supervised, unsupervised, semi-supervised, or a reinforced manner.

4. The system of claim 2, wherein the AI engine includes a pre-processing module that receives the request and the current login session and creates the first transaction timeline for the first list of the one or more transactions for the one or more real estate properties for sale or the second transaction timeline for the second list of the one or more transactions for the one or more third party service providers.

5. The system of claim 2, wherein the AI engine includes a post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

6. The system of claim 1, further comprising:
a natural language processing extraction module determining the one or more transactions for the one or more real estate properties for sale or the one or more transactions for the one or more third party service providers from the request from the system search module.

7. The system of claim 6, wherein the natural language processing extraction module includes a pre-processing module that receives the request and the current login session and creates the first transaction timeline for the first list of the one or more transactions for the one or more real estate properties for sale or the second transaction timeline for the second list of the one or more transactions for the one or more third party service providers.

8. The system of claim 6, wherein the natural language processing extraction module includes a post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

9. The system of claim 1, wherein the non-transitory computer-readable medium further comprises instructions for:
providing accessory services, the accessory services being a lifestyle guide, basics about real estate, design suggestions for colors of paint, or information about taxes and insurance, or luxury items.

10. The system of claim 1, further comprising a document repository, the document repository configured to retain one or more documents associated with the first transaction timeline or the second transaction timeline.

11. The system of claim 1, wherein the aggregated content is provided by an AI document automation system, the AI document automation system generating one or more documents coupled to a compliance and regulatory system based on a location of a first transaction of the one or more transactions or a second transaction of the one or more transactions from the request from the system search module.

12. The system of claim 1, wherein the non-transitory computer-readable medium further comprises instructions for:
providing communication between a first entity and a second entity associated with the one or more transactions for the one or more real estate properties for sale or the one or more transactions for the one or more third party service providers from the request from the system search module.

13. The system of claim 1, wherein the non-transitory computer-readable medium further comprises instructions for:
providing financial payment transactions between a first entity and a second entity associated with the one or more transactions for the one or more real estate properties for sale or the one or more transactions for the one or more third party service providers from the request from the system search module.

14. A computer-implemented method for an artificial intelligence system for real estate transaction management, comprising:
executing on an electronic device;
receiving a request from a system search module at the electronic device, wherein the request includes a current interaction entered by a user in a graphic user interface portion of a touch driven interface displayed at the electronic device, and wherein the request represents at least a portion of a current login session with the user;
determining one or more transactions for one or more real estate properties for sale or one or more transactions for one or more third party service providers from the request from the system search module;
formulating a response to the request that includes aggregated content related to the one or more transactions for the one or more real estate properties for sale or the one or more transactions for the one or more third party service providers from the current login session; and
sending the formulated response to the system search module to be displayed on the electronic device, wherein the response includes a first transaction timeline for a first list of the one or more transactions for the one or more real estate properties for sale or a second transaction timeline for a second list of the one or more transactions for the one or more third party service providers and wherein the response is associated with the current login session associated with the user.

15. The method of claim 14, further comprising:
an AI engine, the AI engine determining the one or more transactions for the one or more real estate properties for sale or the one or more transactions for the one or more third party service providers from the request from the system search module, and the AI engine is a machine learning algorithm that is trained by at least one supervised, unsupervised, semi-supervised, or a reinforced manner.

16. The method of claim 15, wherein the AI engine includes:
a pre-processing module that receives the request and the current login session and creates the first transaction timeline for the first list of the one or more transactions for the one or more real estate properties for sale or a second transaction timeline for the second list of the one or more transactions for the one or more third party service providers; and
a post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

17. The method of claim 14, further comprising:
a natural language processing extraction module determines the one or more transactions for the one or more real estate properties for sale or the one or more transactions for the one or more third party service providers from the request from the system search module.

18. The method of claim 17, wherein the natural language processing extraction module includes:
a pre-processing module that receives the request and the current login session and creates the first transaction timeline for the first list of the one or more transactions for the one or more real estate properties for sale or the second transaction timeline for the second list of the one or more transactions for the one or more third party service providers; and
a post-processing module that monitors and updates a progression status for the first transaction timeline for the first list of the one or more transactions for the one or more real estate properties for sale or the second transaction timeline for the second list of the one or more transactions for the one or more third party service providers for each subsequent login session.

19. The method of claim 14, further comprising:
providing communication between a first entity and a second entity associated with the one or more transactions for the one or more real estate properties for sale or the one or more transactions for the one or more third party service providers from the request from the system search module.

20. The method of claim 14, further comprising:
providing financial payment transactions between a first entity and a second entity associated with the one or more transactions for the one or more real estate properties for sale or the one or more transactions for the one or more third party service providers from the request from the system search module.
